(19) United States
(12) Patent Application Publication
(10) Pub. No.: US 2024/0393643 A1
(43) Pub. Date: Nov. 28, 2024

(54) ILLUMINATION DEVICE

(71) Applicant: Japan Display Inc., Tokyo (JP)

(72) Inventors: Masashi TAKAHATA, Tokyo (JP); Kozo IKENO, Kanagawa (JP)

(21) Appl. No.: 18/793,159

(22) Filed: Aug. 2, 2024

Related U.S. Application Data
(63) Continuation of application No. PCT/JP2023/002518, filed on Jan. 26, 2023.

(30) Foreign Application Priority Data
Feb. 18, 2022 (JP) 2022-024265

(51) Int. Cl. G02F 1/1335; G02F 1/1333

(52) U.S. Cl. CPC G02F 1/133628; G02F 1/133382

(57) ABSTRACT

An illumination device includes a light source configured to emit light, a light adjustment device including at least one liquid crystal panel on a light outputting side of the light source and configured to adjust a light distribution range of light externally emitted from the liquid crystal panel by controlling each of transmittance of light transmitting through the liquid crystal panel and a transmission range of light transmitting through the liquid crystal panel, a temperature sensor configured to acquire information indicating a temperature of the liquid crystal panel, a heater configured to heat the liquid crystal panel, and a controller configured to operate the heater in a case where information indicating a temperature equal to or lower than a predetermined temperature is obtained by the temperature sensor.

### CROSS-REFERENCE TO RELATED APPLICATION

This application is a continuation of International Patent Application No. PCT/JP2023/002518 filed on Jan. 26, 2023 which designates the United States, incorporated herein by reference, and which claims the benefit of priority from Japanese Patent Application No. 2022-024265 filed on Feb. 18, 2022, incorporated herein by reference.

### BACKGROUND

### 1. Technical Field

The present disclosure relates to an illumination device.

### 2. Description of the Related Art

An illumination device the orientation of which is changeable so that the emission range of light can be changed has been known (for example, Japanese Patent Application Laid-open Publication No. 2021-122262 (JP-A-2021-122262)).

In the illumination device disclosed in (JP-A-2021-122262), a movable unit and a driver need to be provided so that the orientation of a light source can be changed. With such a configuration, size increase is unavoidable and a space in which operation of the illumination device is allowed is needed around the illumination device.

Thus, a liquid crystal panel is provided on the emission path of light from a light source to control the transmission range and transmission degree of light in the liquid crystal panel so that light distribution control can be more flexibly performed with a small-sized illumination device. However, the liquid crystal panel has a limited temperature range in which the liquid crystal panel normally operates, and thus measures are needed based on the assumption of a case where the temperature of the liquid crystal panel reaches a low temperature out of the temperature range.

The present disclosure is made in view of the above-described problem and intended to provide an illumination device capable of reducing temperature decrease of a liquid crystal panel provided on the emission path of light from a light source.

### SUMMARY

An illumination device according to an embodiment of the present disclosure includes a light source configured to emit light, a light adjustment device including at least one liquid crystal panel on a light outputting side of the light source and configured to adjust a light distribution range of light externally emitted from the liquid crystal panel by controlling each of transmittance of light transmitting through the liquid crystal panel and a transmission range of light transmitting through the liquid crystal panel, a temperature sensor configured to acquire information indicating a temperature of the liquid crystal panel, a heater configured to heat the liquid crystal panel, and a controller configured to operate the heater in a case where information indicating a temperature equal to or lower than a predetermined temperature is obtained by the temperature sensor.

### BRIEF DESCRIPTION OF THE DRAWINGS

FIG. 1 is a schematic diagram illustrating a main configuration of an illumination device;

FIG. 2 is a schematic diagram illustrating an exemplary configuration of a light adjustment device;

FIG. 3 is a perspective view of a liquid crystal panel according to an embodiment;

FIG. 4 is a plan view illustrating wiring of an array substrate according to the embodiment when viewed from above;

FIG. 5 is a plan view illustrating wiring of a counter substrate according to the embodiment when viewed from above;

FIG. 6 is a plan view illustrating wiring of the liquid crystal panel according to the embodiment when viewed from above;

FIG. 7 is a sectional view along line V-V in FIG. 6;

FIG. 8 is a schematic diagram illustrating exemplary attachment of a temperature sensor to the liquid crystal panel;

FIG. 9 is a schematic diagram illustrating an exemplary configuration of a temperature sensor provided integrally with a liquid crystal panel;

FIG. 10 is a schematic diagram illustrating exemplary acquisition ranges of temperature information on the liquid crystal panel;

FIG. 11 is a schematic diagram illustrating a main configuration of the temperature sensor and a control device;

FIG. 12 is a diagram illustrating a voltage divider circuit constituted by a temperature detection resistor and a reference resistance element;

FIG. 13 is a graph illustrating an exemplary relation between the temperature of the temperature detection resistor in the voltage divider circuit described above with reference to FIG. 12 and the voltage of an electric signal obtained as an output from the voltage divider circuit;

FIG. 14 is a schematic diagram illustrating an exemplary arrangement of a heating region and a partial heating region on the liquid crystal panel;

FIG. 15 is a schematic diagram illustrating a heating resistor provided in each partial heating region and components coupled to the heating resistor;

FIG. 16 is a schematic diagram illustrating exemplary attachment of a heater to a liquid crystal panel;

FIG. 17 is a schematic diagram illustrating an exemplary configuration of the heater provided integrally with a liquid crystal panel;

FIG. 18 is a schematic diagram illustrating an exemplary configuration in which the temperature sensor and the heater are provided on the liquid crystal panel;

FIG. 19 is a schematic diagram illustrating a liquid crystal panel integrally provided with functions of the liquid crystal panel, the temperature sensor, and the heater;

FIG. 20 is a schematic diagram illustrating a liquid crystal panel integrally provided with functions of the liquid crystal panel and the heater;

FIG. 21 is a schematic diagram illustrating a configuration in which the temperature sensor in FIG. 8 is replaced with a temperature sensor and heater;

FIG. 22 is a schematic diagram illustrating a configuration in which the temperature sensor in FIG. 9 is replaced with a temperature sensor and heater;

FIG. 23 is a block diagram illustrating an exemplary main configuration of a system substrate;

FIG. 24 is a diagram illustrating an exemplary main circuit configuration linking direct current flowing through the heating resistor and temperature measurement;

FIG. 25 is a diagram illustrating an exemplary main circuit configuration for linking alternating current flowing through the heating resistor and temperature measurement;

FIG. 26 is a graph illustrating an example of the relation between the pulse width of a PWM signal and voltage applied to the heating resistor;

FIG. 27 is a diagram illustrating an exemplary circuit configuration in which a digital potentiometer is employed as a component related to heat generation amount control of the heating resistor;

FIG. 28 is a graph illustrating a relation that current flowing to a heater device decreases as the potential of a part divided by the digital potentiometer and the heater device increases;

FIG. 29 is a diagram illustrating an exemplary circuit configuration in which ON/OFF circuits are added individually for a temperature sensor and a heater device and each turned on and off to achieve low electric power consumption;

FIG. 30 is a diagram illustrating an exemplary circuit configuration in which the output from the voltage divider circuit is converted into a pulsed wave;

FIG. 31 is a diagram illustrating an exemplary circuit configuration for controlling the size of current flowing to the heating resistor in accordance with the output from the voltage divider circuit described above with reference to FIG. 12 without using an MCU;

FIG. 32 is a graph illustrating turning-off of the heater device at a time point when the temperature sensor reaches 25° C. and illustrating a series of operations when a setting circuit SET in FIG. 31 is set to 1 V;

FIG. 33 is a diagram illustrating an example of achieving precise resistance value measurement by detecting potential difference between both ends of a temperature detection resistor ER in measurement using a differential amplification circuit;

FIG. 34 is a graph illustrating an exemplary relation among the temperature of the temperature detection resistor, the voltage of the output from the voltage divider circuit described above with reference to FIG. 12, sensor output, and heater device input;

FIG. 35 is a flowchart illustrating the process of operation processing of an illumination device 50;

FIG. 36 is a flowchart illustrating the process of heating processing (step S7) in FIG. 35;

FIG. 37 is a diagram illustrating an example of predetermined heater device operation setting described as operation at step S15;

FIG. 38 is a schematic diagram illustrating a main configuration of an illumination device; and

FIG. 39 is a schematic diagram illustrating a main configuration of an illumination device.

### DETAILED DESCRIPTION

Each embodiment of the present disclosure will be described below with reference to the accompanying drawings. What is disclosed herein is merely exemplary, and any modification that could be easily thought of by the skilled person in the art as appropriate without departing from the gist of the invention is contained in the scope of the present disclosure. For clearer description, the drawings are schematically illustrated for the width, thickness, shape, and the like of each component as compared to an actual aspect in some cases, but the drawings are merely exemplary and do not limit the interpretation of the present disclosure. In the present specification and drawings, any element same as that already described with reference to an already described drawing is denoted by the same reference sign, and detailed description thereof is omitted as appropriate in some cases.

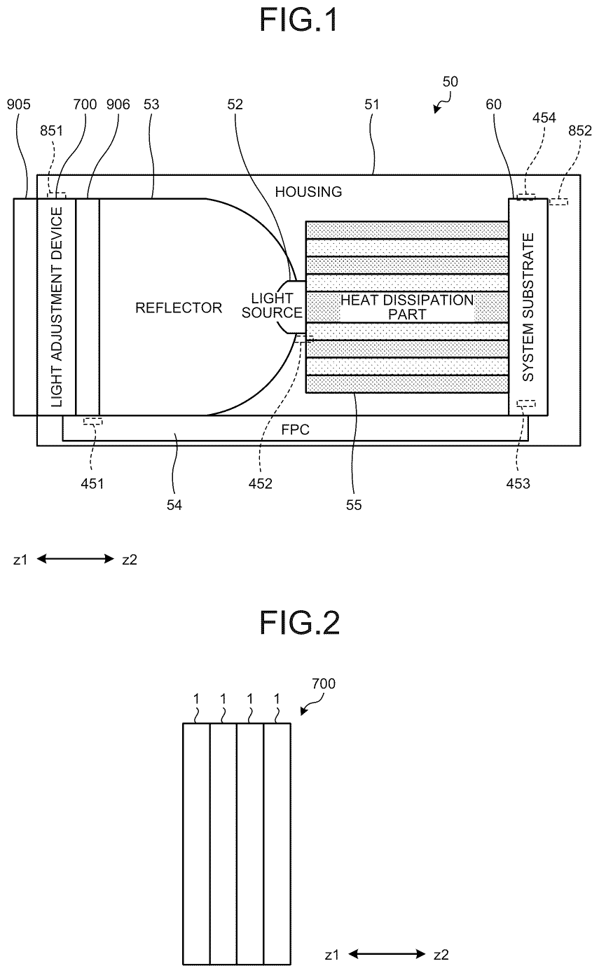

FIG. 1 is a schematic diagram illustrating a main configuration of an illumination device 50. The illumination device 50 includes a housing 51, a light source 52, a reflector 53, a light adjustment device 700, flexible printed circuits (FPC) 54, a system substrate 60, and a heat dissipation part 55. The housing 51 is a housing that houses the light source 52, the reflector 53, the light adjustment device 700, the FPC 54, the system substrate 60, and the heat dissipation part 55. The housing 51 is desirably made of a material (for example, aluminum) with excellent heat dissipation properties.

The light source 52 emits light in accordance with electric power supply. The light source 52 is, for example, a light emitting diode (LED) but may be an electric light of any other form. The light source 52 may be, for example, a filament lamp.

The reflector 53 guides light emitted from the light source 52 to the light adjustment device 700 side. In description of the reflector 53, the light adjustment device 700 side relative to the reflector 53 is referred to as a z1 direction side, and the light source 52 side relative to the reflector 53 is referred to as a z2 direction side. A direction in which the z1 direction is opposite to the z2 direction is referred to as a z direction. The reflector 53 is an optical member having an opening width that enlarges in a conical shape at a plan view point orthogonal to the z direction toward the z1 direction side from the z2 direction side on which the light source 52 is positioned. The reflector 53 guides light emitted from the light source 52 to the light adjustment device 700 side by refraction through a prism or the like or mirrored fabrication of the inner peripheral surface of the conical shape.

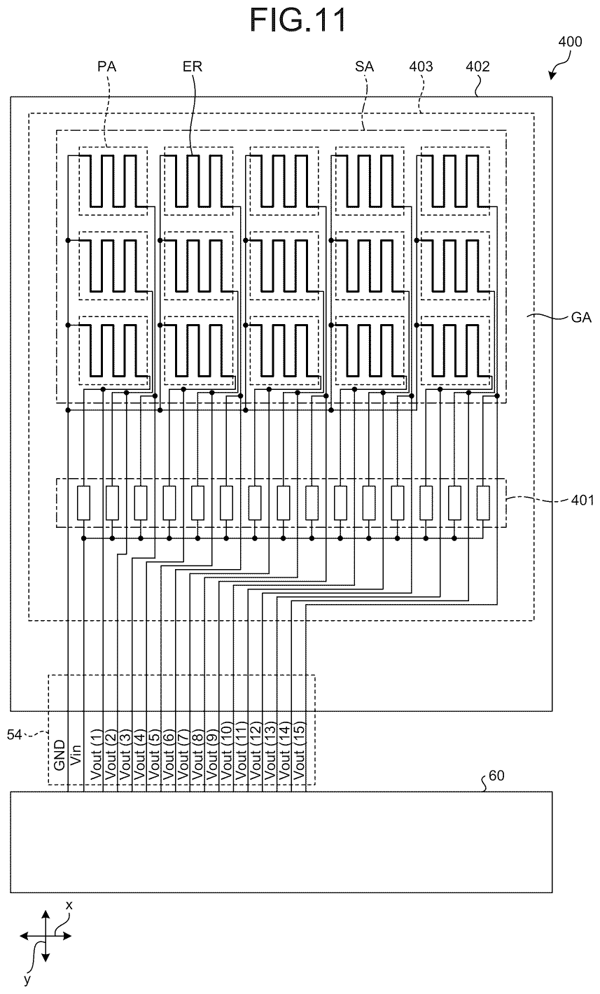

The FPC 54 includes wires coupled to liquid crystal panels 1 included in the light adjustment device 700, and the ground potential line GND and the signal output line Vout(j) to be described later with reference to FIG. 11. The system substrate 60 is a circuit substrate on which one or more circuits are provided. The heat dissipation part 55 includes a component that promotes heat radiation from components provided on the system substrate 60. The component is, for example, a heat sink.

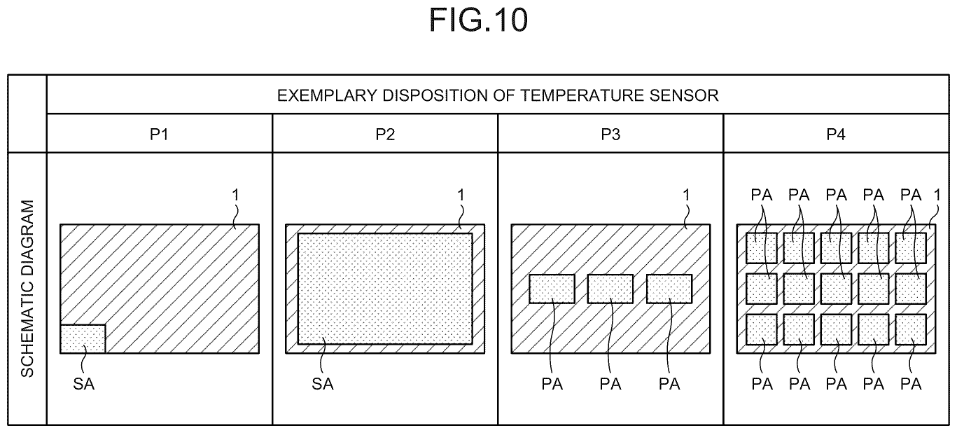

The light adjustment device 700 is provided to enable change of the transmission degree and transmission range of light emitted from the light source 52 and light emitted from the light source 52 and guided by the reflector 53. The light adjustment device 700 is provided with a first component 905 and a second component 906. The first component 905 is provided on the reflector 53 side (z1 direction side) of the light adjustment device 700. The second component 906 is provided on a side (z2 direction side) opposite the first component 905 with respect to the light adjustment device 700. The second component 906 is, for example, a temperature sensor 400 (refer to FIG. 10). The temperature sensor 400 acquires information related to the temperature of each liquid crystal panel 1 included in the light adjustment device 700.

FIG. 2 is a schematic diagram illustrating an exemplary configuration of the light adjustment device 700. As illustrated in FIG. 2, the light adjustment device 700 includes a plurality of liquid crystal panels 1 arranged in the z direction. The light adjustment device 700 illustrated in FIG. 2 includes four liquid crystal panels 1, but the number of liquid crystal panels 1 is not limited to four and may be changed as appropriate.

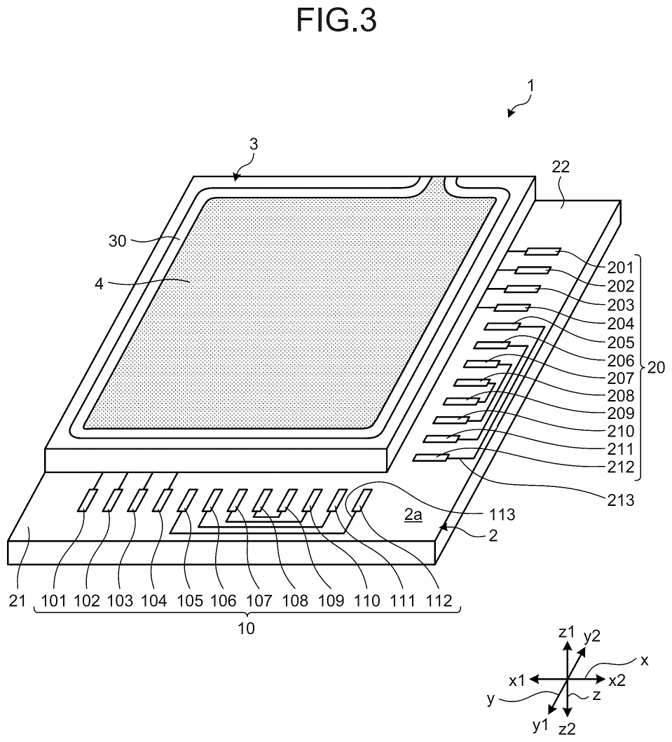

Each liquid crystal panel 1 included in the light adjustment device 700 will be described below with reference to FIGS. 3 to 7.

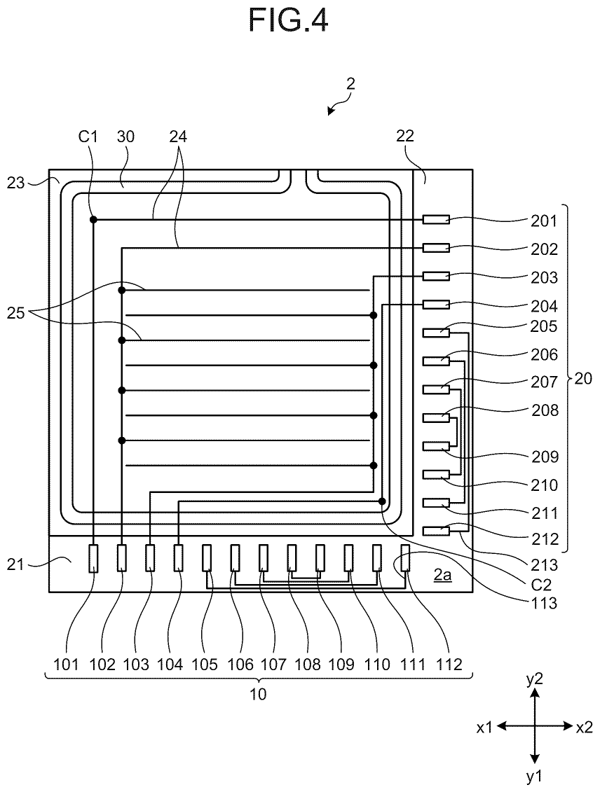

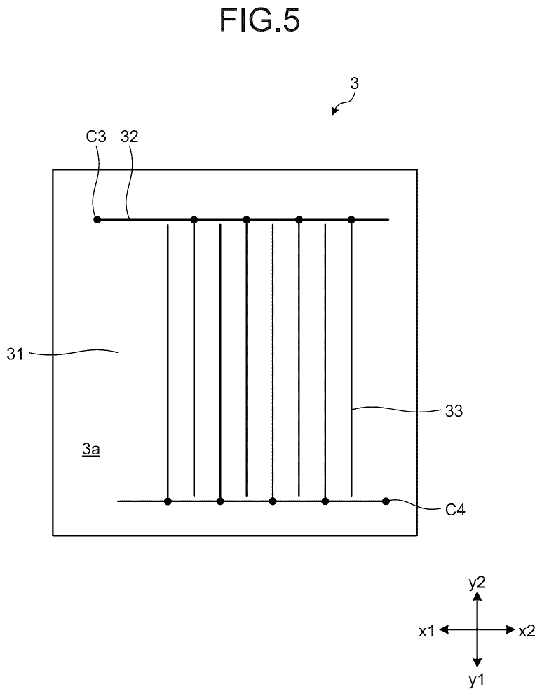

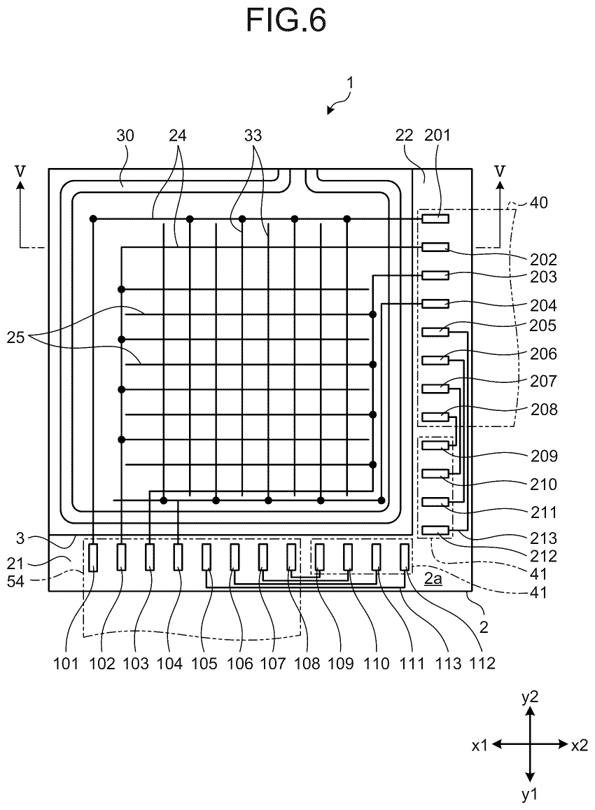

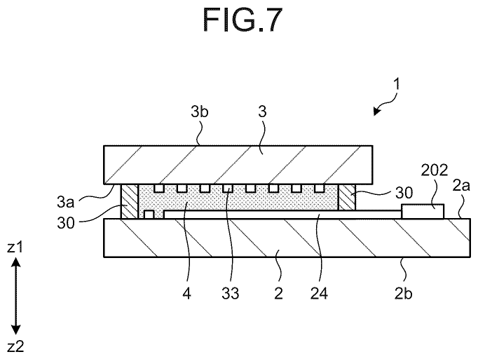

FIG. 3 is a perspective view of a liquid crystal panel 1 according to the embodiment. FIG. 4 is a plan view illustrating wiring of an array substrate 2 according to the embodiment when viewed from above. FIG. 5 is a plan view illustrating wiring of a counter substrate 3 according to the embodiment when viewed from above. FIG. 6 is a plan view illustrating wiring of the liquid crystal panel 1 according to the embodiment when viewed from above. FIG. 7 is a sectional view along line V-V in FIG. 6. Note that, in an xyz coordinate system illustrated in FIGS. 3 to 6, a direction along an x1 direction and an x2 direction is referred to as an x direction. The x1 direction is opposite to the x2 direction. A direction along a y1 direction and a y2 direction is referred to as a y direction. The y1 direction is opposite to the y2 direction. The x direction is orthogonal to the y direction. A plane including the x direction and the y direction is orthogonal to the z direction.

As illustrated in FIG. 3, the liquid crystal panel 1 includes an array substrate 2, a counter substrate 3, a liquid crystal layer 4, and a seal material 30.

As illustrated in FIGS. 3 and 6, the array substrate (first substrate) 2 is larger than the counter substrate (second substrate) 3. In other words, the area of the counter substrate (second substrate) 3 is smaller than the area of the array substrate (first substrate) 2. The array substrate 2 includes a transparent glass 23 (refer to FIG. 4). The counter substrate 3 includes a transparent glass 31 (refer to FIG. 5). In the embodiment, the array substrate 2 and the counter substrate 3 have square shapes in a plan view from above, but the shape of each substrate according to the present invention is not limited to a square shape. A first terminal group area 21 and a second terminal group area 22 are provided on a front surface 2a of the array substrate 2. The first terminal group area 21 is positioned at an end part of the front surface 2a of the array substrate 2 on the y1 side. The second terminal group area 22 is positioned at an end part of the front surface 2a of the array substrate 2 on the x2 side. The first terminal group area 21 and the second terminal group area 22 have L shapes when viewed from above. A first terminal group 10 is disposed in the first terminal group area 21, and a second terminal group 20 is disposed in the second terminal group area 22. Note that since the area of the counter substrate 3 is smaller than the area of the array substrate 2, the first terminal group 10 and the second terminal group 20 are exposed. The first terminal group 10 and the second terminal group 20 are also simply referred to as terminal portions.

As illustrated in FIGS. 3 and 6, the first terminal group 10 includes a first terminal 101, a second terminal 102, a third terminal 103, a fourth terminal 104, a first pad 105, a second pad 106, a third pad 107, a fourth pad 108, a fifth pad 109, a sixth pad 110, a seventh pad 111, and an eighth pad 112. The first terminal 101, the second terminal 102, the third terminal 103, the fourth terminal 104, the first pad 105, the second pad 106, the third pad 107, the fourth pad 108, the fifth pad 109, the sixth pad 110, the seventh pad 111, and the eighth pad 112 are sequentially arranged in a right-left direction from the x1 side toward the x2 side. The first pad 105 and the eighth pad 112 are electrically coupled to each other through a lead line 113. The second pad 106 and the seventh pad 111 are electrically coupled to each other through a lead line 113. The third pad 107 and the sixth pad 110 are electrically coupled to each other through a lead line 113. The fourth pad 108 and the fifth pad 109 are electrically coupled to each other through a lead line 113.

As illustrated in FIGS. 3 and 6, the second terminal group 20 includes a fifth terminal 201, a sixth terminal 202, a seventh terminal 203, an eighth terminal 204, a ninth pad 205, a tenth pad 206, an eleventh pad 207, a twelfth pad 208, a thirteenth pad 209, a fourteenth pad 210, a fifteenth pad 211, and a sixteenth pad 212. The fifth terminal 201, the sixth terminal 202, the seventh terminal 203, the eighth terminal 204, the ninth pad 205, the tenth pad 206, the eleventh pad 207, the twelfth pad 208, the thirteenth pad 209, the fourteenth pad 210, the fifteenth pad 211, and the sixteenth pad 212 are sequentially arranged in a front-back direction from the y2 side toward the y1 side. The ninth pad 205 and the sixteenth pad 212 are electrically coupled to each other through a lead line 213. The tenth pad 206 and the fifteenth pad 211 are electrically coupled to each other through a lead line 213. The eleventh pad 207 and the fourteenth pad 210 are electrically coupled to each other through a lead line 213. The twelfth pad 208 and the thirteenth pad 209 are electrically coupled to each other through a lead line 213.

Note that, as illustrated in FIG. 3, the counter substrate 3 is disposed on an upper side (z1 side) relative to the array substrate 2. The seal material 30 and the liquid crystal layer 4 are provided between the counter substrate 3 and the array substrate 2. The seal material 30 is provided in an annular shape along the outer periphery of the counter substrate 3 and the inside of the seal material 30 is filled with the liquid crystal layer 4. Note that a region in which the liquid crystal layer 4 is provided is an active region, the outside of the liquid crystal layer 4 is a frame region, and the first terminal group area 21 and the second terminal group area 22 are terminal regions.

Wiring of the array substrate 2 and the counter substrate 3 will be described below. Note that, as illustrated in FIG. 7, wiring is provided on a front surface among the front and back surfaces of each substrate. In other words, a surface on which wiring is provided is referred to as a front surface, and a surface opposite the front surface is referred to as a back surface. Specifically, as illustrated in FIG. 7, wiring is provided on the front surface 2a of the upper side among the front surface 2a and a back surface 2b of the array substrate 2, and wiring is provided on the front surface 3a of the lower side among a front surface 3a and a back surface 3b of the counter substrate 3. In this manner, the front surface 2a of the array substrate 2 and the front surface 3a of the counter substrate 3 are disposed facing each other with the liquid crystal layer 4 interposed therebetween.

As illustrated in FIG. 4, wires 24 and first electrodes 25 are provided on the front surface 2a of the transparent glass 23 of the array substrate 2.

Specifically, the first terminal 101 and the fifth terminal 201 are electrically coupled to each other through a wire 24. The second terminal 102 and the sixth terminal 202 are electrically coupled to each other through a wire 24. The third terminal 103 and the seventh terminal 203 are electrically coupled to each other through a wire 24. The fourth terminal 104 and the eighth terminal 204 are electrically coupled to each other through a wire 24. A plurality of first electrodes 25 are coupled to the wire 24 coupling the second terminal 102 and the sixth terminal 202. A plurality of first electrodes 25 are coupled to the wire 24 coupling the third terminal 103 and the seventh terminal 203. Note that couplers C1 and C2 are provided on the wires 24.

As illustrated in FIG. 5, wires 32 and second electrodes 33 are provided on the front surface 3a of the counter substrate 3. Specifically, the wires 32 are provided on the y1 side and the y2 side, respectively. The wires 32 extend in the x direction. The second electrodes 33 are electrically coupled to the wires 32. The second electrodes 33 extend in the y direction. Note that couplers C3 and C4 are provided on the wires 32. In the example illustrated in FIGS. 4 to 6, the number of first electrodes 25 and the number of second electrodes 33 are eight, but these numbers are schematic and are not necessarily the actual numbers of first electrodes 25 and second electrodes 33. The number of first electrodes 25 and the number of second electrodes 33 only need to be equal to or larger than two and thus may be equal to or larger than nine.

As illustrated in FIGS. 6 and 7, the counter substrate 3 is disposed at an interval on the upper side relative to the array substrate 2. The liquid crystal layer 4 is filled between the array substrate 2 and the counter substrate 3. The coupler C1 of the array substrate 2 and the coupler C3 of the counter substrate 3 are electrically coupled to each other through a conductive pillar (not illustrated). The coupler C2 of the array substrate 2 and the coupler C4 of the counter substrate 3 are electrically coupled to each other through a conductive pillar (not illustrated).

As illustrated in FIG. 6, the first terminal 101, the second terminal 102, the third terminal 103, the fourth terminal 104, the first pad 105, the second pad 106, the third pad 107, and the fourth pad 108 can be electrically coupled to the FPC 54 illustrated with dashed and double-dotted lines. For example, the plurality of liquid crystal light panels 1 are each coupled to the D/A converter 64 through the individually provided FPC 54.

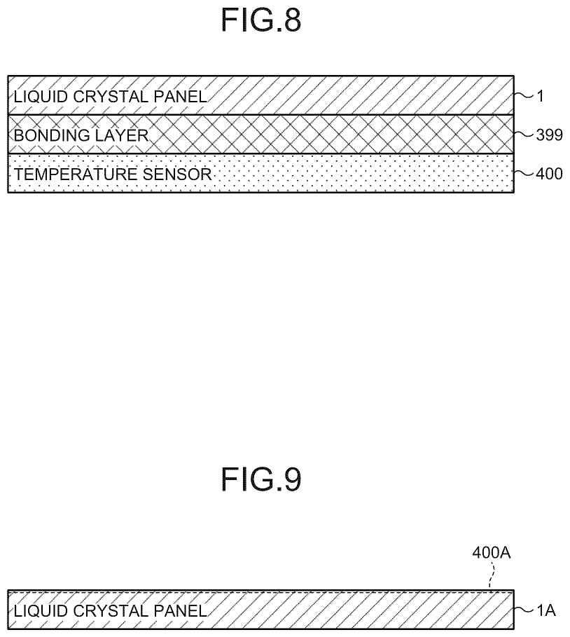

The light adjustment device 700 including the liquid crystal panels 1 described above with reference to FIGS. 3 to 7 functions as a component that adjusts the light distribution range of light externally emitted from the illumination device 50 by controlling the transmittance and transmission range of light transmitting through the liquid crystal panels 1. Control of the transmittance and transmission range of light transmitting through the liquid crystal panels 1 is achieved by control of potential provided to the first electrodes 25 and the second electrodes 33. With the potential control, the orientation of liquid crystal molecules included in the liquid crystal layer 4 is controlled to control the transmittance and transmission range of light transmitting through the liquid crystal panels 1. Note that half of the four liquid crystal panels 1 arranged in the z direction, which are described above with reference to FIG. 2 are liquid crystal cells for p-wave polarization, and the other half are liquid crystal cells for s-wave polarization. Although not illustrated, one surface of the array substrate 2 and one surface of the counter substrate 3, which face each other with the liquid crystal layer 4 interposed therebetween are provided with alignment films having different rubbing directions, respectively. The rubbing direction of the alignment film provided on the one surface of the array substrate 2 is, for example, the y direction. The rubbing direction of the alignment film provided on the one surface of the counter substrate 3 is, for example, the x direction. The following describes a specific example in which the temperature sensor 400 is provided on the liquid crystal panel 1 with reference to FIGS. 8 and 9.

FIG. 8 is a schematic diagram illustrating exemplary attachment of the temperature sensor 400 to the liquid crystal panel 1. As illustrated in FIG. 8, the liquid crystal panel 1 and the temperature sensor 400 are bonded to each other through a bonding layer 399. The bonding layer 399 is a translucent optical member in sheet form with double-sided adhesive properties like optical clear adhesive (OCA). Note that attachment of the temperature sensor 400 to the liquid crystal panel 1 is not limited to attachment through the bonding layer 399 and may be, for example, attachment by bonding using a bonding agent.

FIG. 9 is a schematic diagram illustrating an exemplary configuration of a temperature sensor 400A provided integrally with a liquid crystal panel 1A. The liquid crystal panel 1A integrally provided with functions of the liquid crystal panel 1 and functions of the temperature sensor 400 as illustrated in FIG. 9 may be provided at the light adjustment device 700 in place of the liquid crystal panel 1 to which the temperature sensor 400 to attached. In this case, the temperature sensor 400A functions in the same manner as the temperature sensor 400. The temperature sensor 400A is stacked with the second electrodes 33 through, for example, an insulating layer on the liquid crystal layer 4 side relative to the counter substrate 3.

FIG. 10 is a schematic diagram illustrating exemplary acquisition ranges of temperature information on the liquid crystal panel 1. In the following description, a temperature detection region SA and a partial temperature detection region PA are regions in which temperature information is acquired by the temperature sensor 400 or the temperature sensor 400A. For example, as in Example P1 in FIG. 10, the temperature detection region SA may be a region as part of a plate surface of the liquid crystal panel 1 in a rectangular shape, which is located near one of the four corners, or as in Example P2, the temperature detection region SA may be a region that covers most of the plate surface of the liquid crystal panel 1 in a rectangular shape. Alternatively, as in Examples P3 and P4, a plurality of partial temperature detection regions PA may be disposed in the plate surface of the liquid crystal panel 1 in a rectangular shape.

The temperature sensor 400 provided as a component corresponding to Example P4 in FIG. 10 will be described below with reference to FIG. 11.

FIG. 11 is a schematic diagram illustrating a main configuration of the temperature sensor 400 and a control device. As illustrated in FIG. 11, the temperature sensor 400 includes a sensor base material 402 and a sensor part 403.

The sensor base material 402 has a temperature detection region SA and a peripheral region GA. The temperature detection region SA includes a plurality of partial temperature detection regions PA. The plurality of partial temperature detection regions PA are provided with a plurality of temperature detection resistors ER, respectively, included in the sensor part 403. Note that the z direction is the normal direction of the sensor base material 402.

The temperature detection resistors ER are electric resistors made of a compound (metal compound) containing alloy and metal, or a metal. The temperature detection resistor ER may be a multilayered body in which a plurality of kinds of materials corresponding to at least one of metal, alloy, and metal compound are stacked. Alloy or the like in the description of the first embodiment means a material that can be employed as a composition of each temperature detection resistor ER and a heating resistor 811. In the example illustrated in FIG. 11, the temperature detection resistor ER has a configuration in which a plurality of L-shaped wires with their long sides aligned with the y direction are coupled in the x direction. In this configuration, the plurality of L-shaped wires are coupled to achieve the form of the temperature detection resistor ER such that the short sides of two L-shaped wires adjacent to each other in the x direction are staggered in the y direction.

The peripheral region GA is a region between the outer periphery of the temperature detection region SA and the end part of the sensor base material 402 and is a region in which the temperature detection resistors ER are not provided. A plurality of reference resistance elements 401 are provided in the peripheral region GA. The temperature sensor is constituted by the temperature detection resistors ER provided in the partial temperature detection regions PA and the reference resistance elements 401 provided in the peripheral region GA.

The temperature detection resistors ER and the reference resistance elements 401 are coupled to wires provided in the FPC 54. The wires included in the FPC 54 are coupled to the system substrate 60. The wires provided in the FPC 54 include a ground potential line GND, a signal input line Vin, and signal output lines Vout. The signal output lines Vout collectively mean signal output lines, such as signal output lines Vout(1), Vout(2), . . . , Vout(15), which are provided in a plural number corresponding to the number of temperature detection resistors ER. The ground potential line GND illustrated in FIG. 11 is coupled to one end of each temperature detection resistor ER. The ground potential line GND provides ground potential to each temperature detection resistor ER. The signal input line Vin is coupled to one end of each reference resistance element 401. Each signal output line Vout is coupled to the other end of the corresponding temperature detection resistor ER and the other end of the corresponding reference resistance element 401.

A drive signal of the temperature sensor 400 is input from the signal input line Vin. The drive signal is output to the signal output lines Vout through the temperature sensor 400. The strength of a signal output from each signal output line Vout varies with the temperature of the temperature detection resistor ER coupled to the signal output line Vout. In other words, the temperature of each of the partial temperature detection regions PA provided with the temperature detection resistors ER can be detected based on a signal output from the corresponding signal output line Vout.

The number of electric resistance elements provided as the reference resistance elements 401 and the number of signal output lines Vout correspond to the number of temperature detection resistors ER. The plurality of electric resistance elements are coupled in parallel to one signal input line Vin. The example illustrated in FIG. 11 is a case of j=15 where j is the number of temperature detection resistors ER. Signals corresponding to the temperatures of the 15 temperature detection resistors ER are output from the signal output lines Vout(1), Vout(2), . . . , Vout(15), respectively. Note that the number of temperature detection resistors ER is not limited to 15 and may be modified as appropriate. In addition, specific forms of the temperature sensor 400, such as wiring shapes of the temperature detection resistors ER are not limited and may be modified as appropriate.

Note that the configuration of the above-described embodiment is an example in a case where the temperature sensor included in the illumination device 50 is the temperature sensor 400, but a sensor configured to acquire information indicating the temperature of each component of the illumination device 50 may be additionally provided. As a specific example, any of temperature sensors 451, 452, 453, and 454 illustrated in FIG. 1 may be provided. The temperature sensor 451 is provided at a position extremely close to the light adjustment device 700 in the FPC 54. The temperature sensor 451 can function extremely similarly to the temperature sensor 400 described above with reference to FIG. 10, and thus in a case where the temperature sensor 451 is disposed, the temperature sensor 400 may be omitted and temperature measured by the temperature sensor 451 may be regarded as the temperature of the liquid crystal panel 1 included in the light adjustment device 700. The temperature sensor 452 is provided at a position in contact with or close to the light source 52. The temperature sensor 453 is provided at a position in contact with or close to a circuit provided on the system substrate 60. The temperature sensor 454 is provided at the housing 51.

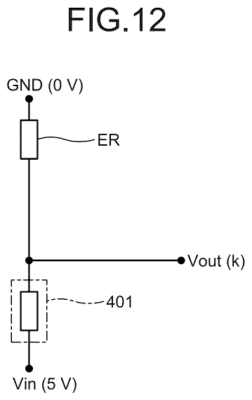

FIG. 12 is a diagram illustrating a voltage divider circuit constituted by the temperature detection resistor ER and the reference resistance element 401. Each temperature detection resistor ER and the corresponding reference resistance element 401 described above with reference to FIG. 11 constitute the voltage divider circuit as illustrated in FIG. 12. The above-described signal output lines Vout(1), Vout(2), . . . , Vout(15) can be each regarded as an output line of the voltage divider circuit. Since each reference resistance element 401 has a fixed electric resistance value, an output from the signal output line Vout(k) of the voltage divider circuit depends on the electric resistance value of the temperature detection resistor ER that functions as a variable resistor. The electric resistance value of the temperature detection resistor ER corresponds to the temperature of the temperature detection resistor ER. In other words, the size of an output from the signal output line Vout(k) corresponds to a temperature at a place where the temperature detection resistor ER is provided. Thus, with the configuration in which the temperature sensor 400 including the temperature detection resistors ER is provided in the liquid crystal panel 1, information related to a temperature at the place where each temperature detection resistor ER is provided can be obtained based on an output from the corresponding signal output line Vout(k). Note that k is a natural number equal to or smaller than j. Hereinafter, unless otherwise stated, the “voltage divider circuit described above with reference to FIG. 12” means a voltage divider circuit that includes the reference resistance element 401 and the temperature detection resistor ER and output of which depends on the temperature of the temperature detection resistor ER.

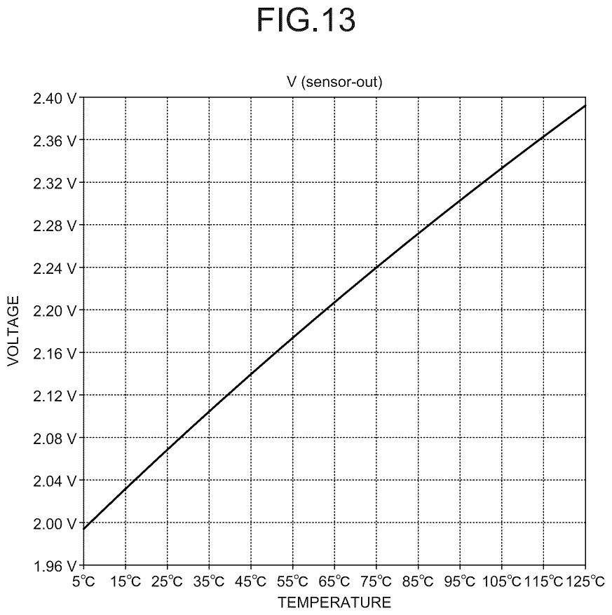

FIG. 13 is a graph illustrating an exemplary relation between the temperature of the temperature detection resistor ER in the voltage divider circuit described above with reference to FIG. 12 and the voltage of an electric signal obtained as an output from the voltage divider circuit. As the temperature of the temperature detection resistor ER increases, the electric resistance value of the voltage divider circuit described above with reference to FIG. 12 on the ground (GND) side increases, and accordingly, the voltage of the output from the voltage divider circuit increases.

In the embodiment, a circuit provided on an integrated circuit performs software processing of converting an analog signal that is an output from the signal output line Vout(k) into a digital signal and deriving a temperature indicated by the digital signal, or circuit logic processing based on the same algorithm as the software processing. A configuration for the conversion from an analog signal into a digital signal and the integrated circuit (for example, an MCU 62 to be described later) may be identical or separated from each other.

The description with reference to FIG. 11 is made on the configuration of the temperature sensor 400 corresponding to Example P4 in FIG. 10, but in a case where Example P3 in FIG. 10 is employed, the numbers of partial temperature detection regions PA (temperature detection resistors ER) and resistors provided as the reference resistance elements 401 in FIG. 11 are three, and accordingly, a configuration with j=3 is employed. In a case where Examples P1 and P2 in FIG. 10 are employed, the partial temperature detection region PA (temperature detection resistor ER) provided in the temperature detection region SA in FIG. 11 is regarded as one variable resistor in the voltage divider resistor described above with reference to FIG. 12, one electric resistor is provided at the reference resistance element 401, and accordingly, a configuration with j=1 is employed. In a case where the temperature sensor 400A in FIG. 9 is employed, the sensor base material 402 of the temperature sensor 400 illustrated in FIG. 11 is replaced with a substrate (for example, the counter substrate 3) of the liquid crystal panel 1.

An output from each signal output line Vout(k) is transmitted to circuits provided on the system substrate 60 through the FPC 54. When, based on the output from the signal output line Vout(k), having obtained information indicating that the temperature at a place where the corresponding temperature detection resistor ER is provided, in other words, the temperature of the liquid crystal panel 1 is equal to or higher than a predetermined temperature, a circuit provided on the system substrate 60 performs temperature increase reduction control. The temperature increase reduction control is operation control of the illumination device 50, which is performed to reduce further increase of the temperature of the liquid crystal panel 1.

Note that a multiplexer may be provided on a signal output path from a signal output line Vout(j). With the multiplexer provided, it is possible to reduce the number of terminals through which a component (for example, a circuit provided on the system substrate 60) for output reception from the signal output lines Vout(k) receives outputs. However, the component may be individually coupled to the signal output line Vout(j).

In a case where the first component 905 is the temperature sensor 400, under an environment with such a low temperature that air outside the illumination device 50 affects operation of the light adjustment device 700, decrease of the temperature of the light adjustment device 700 due to the environment can be more quickly and easily sensed by the temperature sensor 400. The temperature sensor 400 may be provided not as the first component 905 but as the second component 906. In a case where the second component 906 is the temperature sensor 400, increase of the temperature of the light adjustment device 700 due to radiation heat from components provided on the z2 direction side relative to the light adjustment device 700 can be more quickly and easily sensed by the temperature sensor 400. The components provided on the z2 direction side relative to the light adjustment device 700 are the light source 52 and circuits provided on the system substrate 60 to be described later.

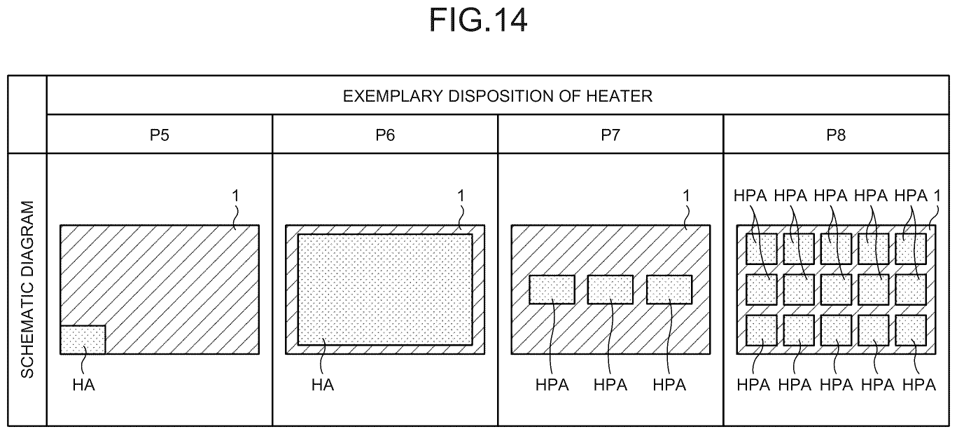

The following describes a mechanism for increasing the temperature of the light adjustment device 700 with reference to FIGS. 14 to 23. In a case where the second component 906 is the temperature sensor 400, a heater 800 is provided as the first component 905. In a case where the first component 905 is the heater 800, under an environment with such a low temperature (for example, lower than a predetermined temperature to be described later) that air outside the illumination device 50 affects operation of the light adjustment device 700, the z1 direction side of the liquid crystal panel 1 positioned closest to the z1 direction side among the liquid crystal panels 1 included in the light adjustment device 700, which is relatively largely affected by the environment, can be more quickly heated. Thus, influence on operation of the light adjustment device 700 due to too low temperature of the light adjustment device 700 can be more easily reduced. In a case where the first component 905 is the temperature sensor 400, the heater 800 is provided as the second component 906, for example. In a case where the second component 906 is the heater 800, intensive and quicker heating can be performed, including heating effect of the light adjustment device 700 due to radiation heat from components provided on the z2 direction side relative to the light adjustment device 700.

FIG. 14 is a schematic diagram illustrating an exemplary arrangement of a heating region HA and a partial heating region HPA on the liquid crystal panel 1. In the following description, the heating region HA and the partial heating region HPA mean regions in which a heating resistor 811 of the heater 800 or a heating resistor 811 of a heater 801 is provided. For example, as in Example P5 in FIG. 14, the heating region HA may be a region as part of a plate surface of the liquid crystal panel 1 in a rectangular shape, which is located near one of the four corners, or as in Example P6, the heating region HA may be a region that covers most of the plate surface of the liquid crystal panel 1 in a rectangular shape.

Alternatively, as in Examples P7 and P8, a plurality of partial heating regions HPA may be disposed in the plate surface of the liquid crystal panel 1 in a rectangular shape.

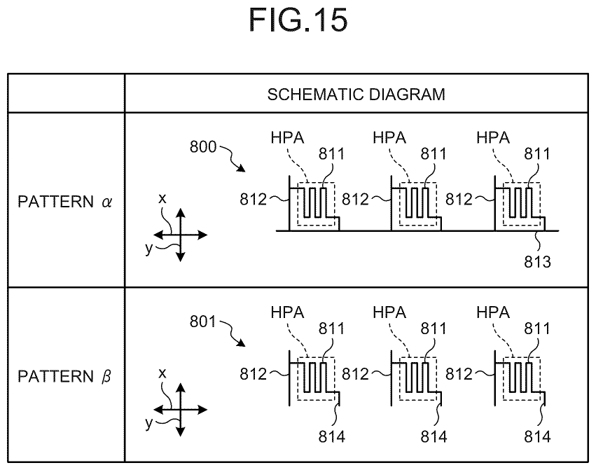

The partial heating region HPA provided as a component corresponding to Example P7 in FIG. 14 will be described below with reference to FIG. 15.

FIG. 15 is a schematic diagram illustrating a heating resistor 811 provided in the partial heating region HPA and components coupled to the heating resistor 811. The heating resistor 811 is an electric resistor made of an alloy or other material. In the example illustrated in FIG. 15, each heating resistor 811 has a configuration in which a plurality of L-shaped wires with their long sides aligned with the y direction are coupled in the x direction. In this configuration, the L-shaped wires are coupled to achieve the form of the heating resistors 811 such that the short sides of two L-shaped wires adjacent to each other in the x direction are staggered in the y direction.

As illustrated with pattern α in FIG. 15, the heater 800 includes the heating resistors 811, wires 812, and a wire 813. Each wire 812 is individually provided for a heating resistor 811 and coupled to one end of a wire of the heating resistor 811. The wire 813 is coupled to the other ends of the wires of the heating resistors 811. Each wire 812 and the wire 813 are not directly coupled to each other but are coupled to each other through the corresponding heating resistor 811. As a specific example, each wire 812 and the wire 813 are formed in different wiring layers stacked with an insulating layer interposed therebetween. The heating resistors 811 may be formed in the same layer as any one of the wires 812 and the wire 813 or may be formed in a layer different from those of the wires 812 and the wire 813.

A heater 801 may be employed in place of the heater 800. As illustrated with pattern β in FIG. 15, the heater 801 includes the heating resistors 811, the wires 812, and wires 814. Each wire 814 is individually provided for a heating resistor 811 and coupled to the other end of a wire of the heating resistor 811.

Each wire 812 is coupled to one of the anode and cathode of a power source. The wire 813 and the wires 814 are coupled to the other of the anode and cathode of the power source. When the power source is turned on, the heating resistors 811 are supplied with electric power and generate heat, and accordingly, the liquid crystal panel 1 is heated. When the power source is turned off, the heating ends. When a switch capable of opening and closing a circuit is provided between each wire 814 and the power source, switching of the electric power supply can be individually controlled for each partial heating region HPA.

The description with reference to FIG. 15 is made on the configuration corresponding to Example P7 in FIG. 14, but in a case where Example P8 in FIG. 14 is employed, disposition of x×y: 5×3=15 of the partial heating regions HPA (heating resistors 811) in FIG. 15 is employed. In cases where Examples P5 and P6 in FIG. 14 are employed, the heating region HA has the same configuration as one partial heating region HPA.

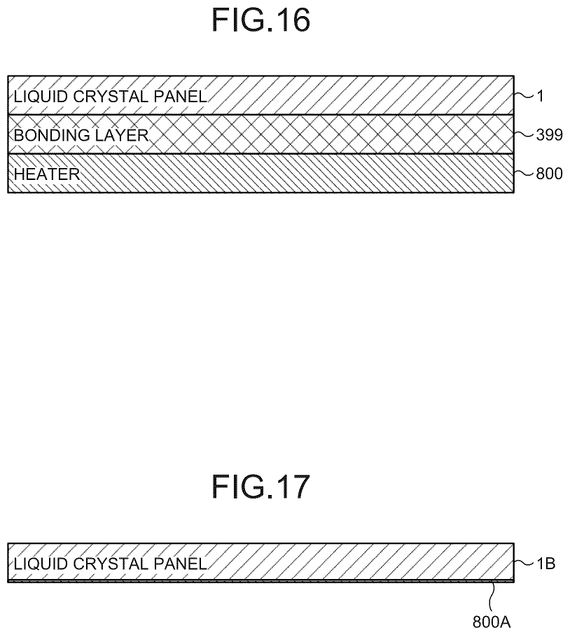

The following describes a specific example in which the heater 800 is provided on a liquid crystal panel 1 with reference to FIGS. 16 to 22.

FIG. 16 is a schematic diagram illustrating exemplary attachment of the heater 800 to the liquid crystal panel 1. As illustrated in FIG. 16, the liquid crystal panel 1 and the heater 800 are bonded to each other through a bonding layer 399, for example. Attachment of the heater 800 to the liquid crystal panel 1 is not limited to attachment through the bonding layer 399 and may be, for example, attachment by bonding using a bonding agent.

FIG. 17 is a schematic diagram illustrating an exemplary configuration of a heater 800A provided integrally with a liquid crystal panel 1B. The liquid crystal panel 1B integrally provided with functions of the liquid crystal panel 1 and functions of the heater 800 as illustrated in FIG. 17 may be provided at the light adjustment device 700 in place of the liquid crystal panel 1 to which the heater 800 is attached. In this case, the heater 800A functions in the same manner as the heater 800. The heater 800A includes the heating resistors 811 stacked with the second electrodes 33 through, for example, an insulating layer on the liquid crystal layer 4 side relative to the counter substrate 3, the wires 812, and the wire 813 or the wires 814.

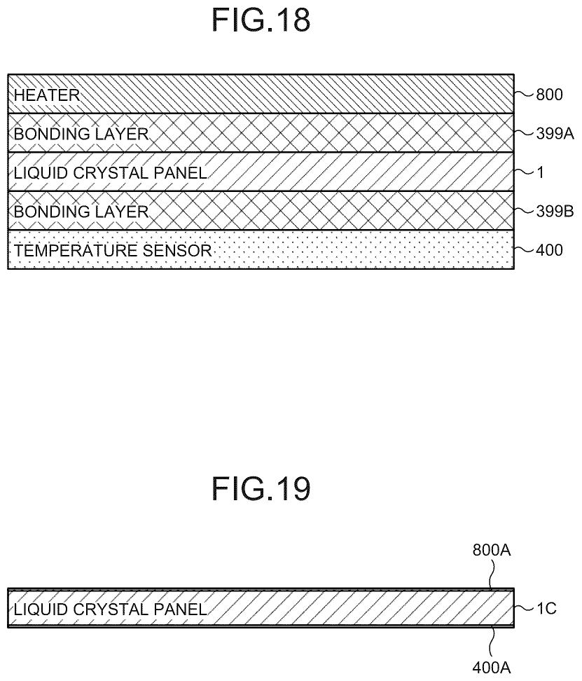

FIG. 18 is a schematic diagram illustrating an exemplary configuration in which the temperature sensor 400 and the heater 800 are provided on the liquid crystal panel 1. As illustrated in FIG. 18, the heater 800 may be provided on one surface side of the plate surface of the liquid crystal panel 1, and the temperature sensor 400 may be provided on the other surface side. A bonding layer 399A is interposed between the liquid crystal panel 1 and the heater 800. A bonding layer 399B is interposed between the liquid crystal panel 1 and the temperature sensor 400. The bonding layers 399A and 399B have the same configuration as the bonding layer 399 described above.

FIG. 19 is a schematic diagram illustrating a liquid crystal panel 1C integrally provided with functions of the liquid crystal panel 1, the temperature sensor 400, and the heater 800. As illustrated in FIG. 19, the temperature sensor 400A described above with reference to FIGS. 9 to 12 may be provided on the one surface side of the liquid crystal panel 1, and the heater 800A described above with reference to FIGS. 14, 15, and 17 may be provided on the other surface side of the liquid crystal panel 1. As described above with reference to FIG. 9, the temperature sensor 400A may be formed on the counter substrate 3 or the array substrate 2. Alternatively, the temperature sensor 400A may be stacked with the first electrodes 25 or the second electrodes 33 through, for example, an insulating layer on the liquid crystal layer 4 side or may be formed on a plate surface opposite a plate surface facing the liquid crystal layer 4 among plate surfaces of one of the array substrate 2 and the counter substrate 3. The heater 800A is formed on the other of the array substrate 2 and the counter substrate 3, on which the temperature sensor 400A is not formed. The heater 800A may be stacked with the first electrodes 25 or the second electrodes 33 through, for example, an insulating layer or may be formed on a plate surface opposite a plate surface facing the liquid crystal layer 4 among plate surfaces of the other of the array substrate 2 and the counter substrate 3.

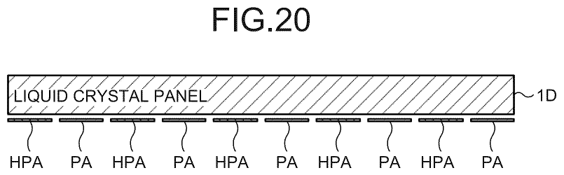

FIG. 20 is a schematic diagram illustrating a liquid crystal panel 1D integrally provided with functions of the liquid crystal panel 1, the temperature sensor 400, and the heater 800. As illustrated in FIG. 20, the partial temperature detection regions PA described above with reference to FIGS. 10 and 11 and the partial heating regions HPA described above with reference to FIGS. 14 and 15 may be alternately arranged along a plate surface of the liquid crystal panel 1 on the one surface side of the liquid crystal panel 1. According to the liquid crystal panel 1D, the partial temperature detection regions PA and the partial heating regions HPA can be provided on the one surface side of the liquid crystal panel 1.

The temperature detection resistors ER (refer to FIG. 11) may be used as the heating resistors 811 (refer to FIG. 15). In this case, a detection duration, in which temperature detection of the liquid crystal panel 1 based on the electric resistance values of the temperature detection resistors ER is performed, and a heating duration, in which heating of the liquid crystal panel 1 due to heat generation by the temperature detection resistors ER is performed with electric power supplied to the temperature detection resistors ER when heating is necessary, occur in an alternate manner in time, that is, what is called time division control is performed. Electric power supply to the temperature detection resistors ER in the heating duration is performed when heating is necessary. In other words, electric power supply to the temperature detection resistors ER in the heating duration is not performed when heating is unnecessary. Determination of the necessity of heating is performed based on, for example, a predetermined temperature threshold. Specifically, it is determined that heating is needed when the temperature of the liquid crystal panel 1 detected in the detection duration is equal to or lower than the temperature threshold or lower than the temperature threshold, and otherwise, it is determined that heating is unnecessary. Various kinds of processing related to the determination are performed by, for example, a circuit provided on the system substrate 60.

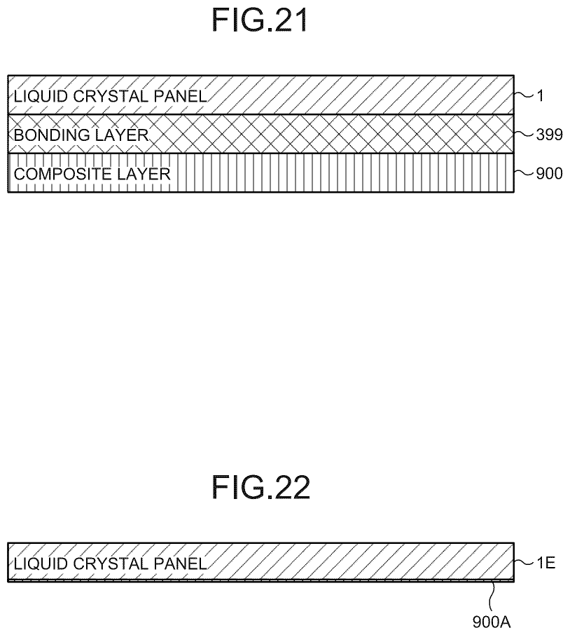

FIG. 21 is a schematic diagram illustrating a configuration in which the temperature sensor 400 in FIG. 8 is replaced with a temperature sensor and heater 900. The temperature sensor and heater 900 is a configuration in which each temperature detection resistor ER (refer to FIG. 11) of the temperature sensor 400 can be used as a heating resistor 811 (refer to FIG. 15) of the heater 800. Specifically, a closed circuit including the temperature detection resistor ER can switch between a first path including a reference resistance element 401 and a second path including no reference resistance element 401. When the first path is established, the closed circuit functions as the voltage divider described above with reference to FIG. 12. When a second circuit is established, the temperature detection resistor ER is coupled to a wire 812 and a wire 813 or 814 like the heating resistor 811 described above with reference to FIG. 15 and a current flows to the temperature detection resistor ER, and accordingly, the temperature detection resistor ER generates heat and the closed circuit functions like the heating resistor 811.

FIG. 22 is a schematic diagram illustrating a configuration in which the temperature sensor 400A in FIG. 9 is replaced with a temperature sensor and heater 900A. A liquid crystal panel 1E integrally provided with functions of the liquid crystal panel 1 and the temperature sensor and heater 900 as illustrated in FIG. 22 may be provided to the light adjustment device 700 in place of the liquid crystal panel 1 to which the temperature sensor and heater 900 is attached as illustrated in FIG. 21. In this case, the temperature sensor and heater 900A functions in the same manner as the temperature sensor and heater 900. Similarly to the temperature sensor 400A described above, the temperature sensor and heater 900A is formed on the array substrate 2 or the counter substrate 3.

Although the above description with reference to FIGS. 13 to 22 is made on the heater 800 and components that function in the same manner as the heater 800, a component for heating the illumination device 50 is not limited thereto. For example, at least one of heaters 851 and 852 in FIG. 1 may be provided in addition. The heater 851 is provided at a position in contact with or close to the light adjustment device 700 on a side not facing a plate surface of the light adjustment device 700. The heater 852 is provided at a position in contact with or close to the system substrate 60. With heating by the heater 851, the temperature of the light adjustment device 700 can be easily adjusted to a temperature that is more suitable for operation of the light adjustment device 700 even when external air is at such a low temperature that operation of the light adjustment device 700 is affected. With heating by the heater 852, the temperature of the light adjustment device 700 can be easily adjusted to a temperature that is more suitable for operation of the circuit even when there is a probability that, due to influence of such external air, the temperature of a circuit provided on the system substrate 60 becomes such a low temperature that operation of the circuit is affected.

The first component 905 is provided at the liquid crystal panel 1 closest to the z1 direction side among the liquid crystal panels 1 included in the light adjustment device 700. The second component 906 is provided at the liquid crystal panel 1 closest to the z2 direction side among the liquid crystal panels 1 included in the light adjustment device 700.

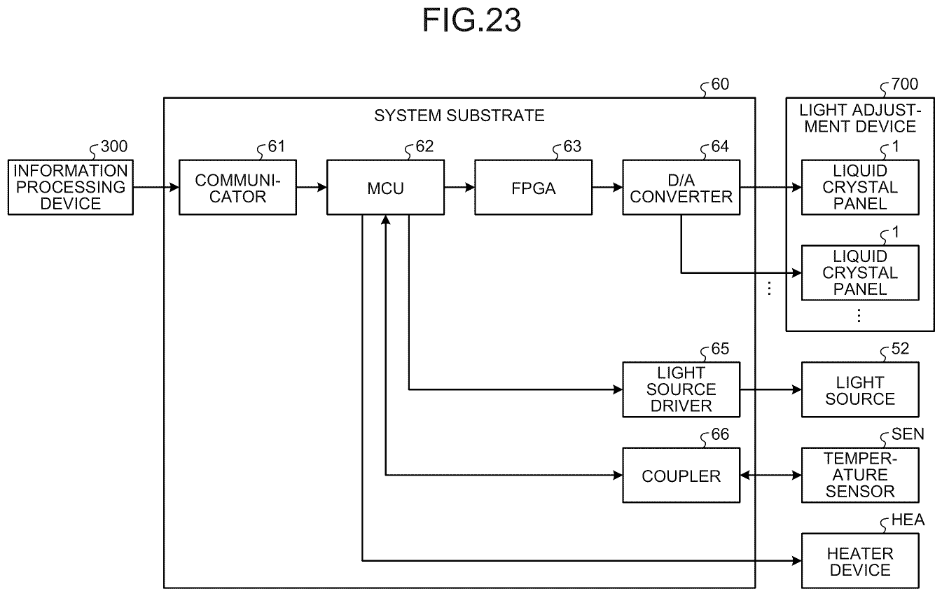

FIG. 23 is a block diagram illustrating an exemplary main configuration of the system substrate 60. The system substrate 60 is provided with, for example, a communicator 61, a micro controller unit (MCU) 62, a field programmable gate array (FPGA) 63, a digital-analog (D/A) converter 64, a light source driver 65, and a coupler 66.

The communicator 61 performs communication with an external information processing device 300. Specifically, the communicator 61 includes, for example, a circuit that functions as a network interface controller (NIC). The communicator 61 receives a signal transmitted from the information processing device 300 and including a command related to operation of the illumination device 50 and outputs information indicating the command to the MCU 62. Note that the information processing device 300 is a portable terminal such as a smartphone but is not limited thereto. The information processing device 300 may be a fixed information processing device such as a server or a personal computer (PC) provided for control of the illumination device 50 or may be an information processing device in another form not exemplarily described herein.

The command related to operation of the illumination device 50 and transmitted from the information processing device 300 is a command that designates ON/OFF of light emission by the illumination device 50, a light emission range, light intensity, or the like, but is not limited thereto and may include any matter that can be individually designated in an operation control range of the illumination device 50.

The MCU 62 outputs various signals to the FPGA 63, the light source driver 65, and the coupler 66 in accordance with the command related to operation of the illumination device 50 and obtained from the information processing device 300 through the communicator 61. In other words, the MCU 62 controls various components included in the illumination device 50 so that the illumination device 50 operates in accordance with operation from the information processing device 300.

As described above, the MCU 62 acquires an output from each signal output line Vout(k) and performs the temperature increase reduction control in a case where the output indicates that the temperature of a liquid crystal panel 1 has become equal to or higher than the predetermined temperature. The MCU 62 also controls operation of a heater device HEA. The heater device HEA is, for example, the heater 800 but not limited thereto and may be any one or more of the heaters 800A, 851, and 852, may be a partial heating region HPA described above with reference to FIG. 14, or may be the temperature sensor and heater 900 or the temperature sensor and heater 900A described above with reference to FIGS. 21 and 22. Moreover, the heat dissipation part 55 may be provided with a heater device to apply heat from the heat dissipation part 55 to the light adjustment device 700.

Under control by the MCU 62, the FPGA 63 performs information processing for controlling operation of the light adjustment device 700 and outputs a signal indicating a result of the information processing to the D/A converter 64. For example, in a case where designation related to a light emission range is included in the command related to operation of the illumination device 50 and transmitted from the information processing device 300, the FPGA 63 performs information processing for operating the light adjustment device 700 so that light is emitted to the emission range corresponding to the designation.

The D/A converter 64 has a configuration that outputs, based on a digital signal that is a signal from the FPGA 63, an analog signal for operating a plurality of liquid crystal panels 1 included in the light adjustment device 700. The configuration may be one circuit or may include a plurality of circuits.

The light source driver 65 is a controller that performs, under control by the MCU 62, ON/OFF control of the light source 52 and light emission intensity control when a light source 52 is ON. The controller may be one circuit or may include a plurality of circuits.

The coupler 66 is an interface through which the MCU 62 is coupled to inputs and outputs (the ground potential line GND, the signal input line Vin, and the signal output lines Vout described above) of a temperature sensor SEN. The coupler 66 is coupled to the MCU 62 and interposed on a signal transmission path between the MCU 62 and the temperature sensor SEN.

The temperature sensor SEN is, for example, the temperature sensor 400 but not limited thereto and may be any one or more of the temperature sensors 400A, 451, 452, 453, and 454, may be a partial temperature detection region PA described above with reference to FIG. 10, or may be the temperature sensor and heater 900 described above with reference to FIGS. 19 and 20.

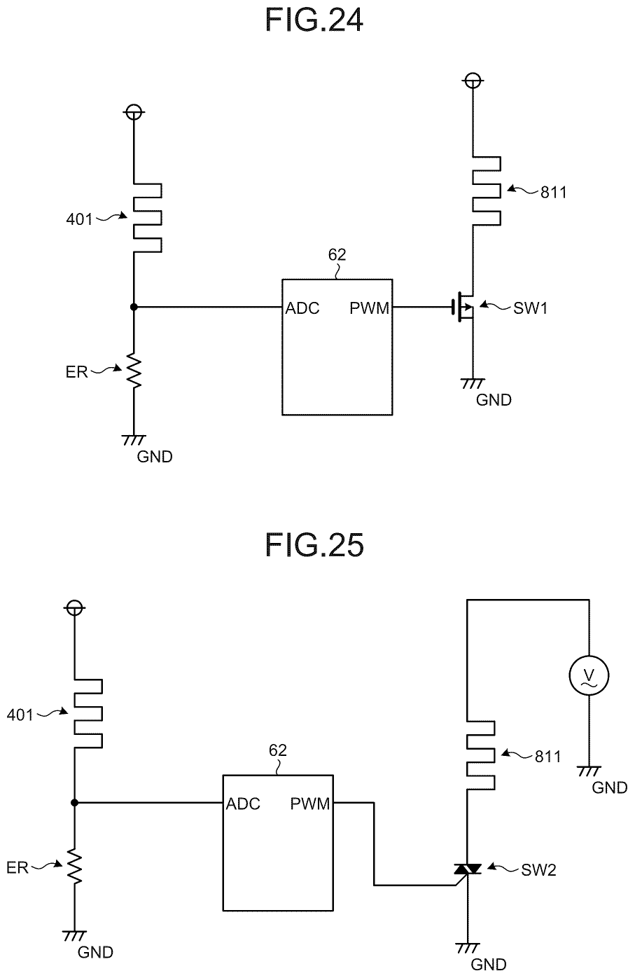

The following describes control related to heating by the heating resistor 811 with reference to FIGS. 24 to 37.

FIG. 24 is a diagram illustrating an exemplary main circuit configuration linking direct current flowing through the heating resistor and temperature measurement. In the configuration illustrated in FIG. 24, the MCU 62 is coupled to the voltage divider circuit described above with reference to FIG. 12 and a switch SW1. An output from the voltage divider circuit described above with reference to FIG. 12 is input to the MCU 62 as an analog signal indicating the temperature of the temperature detection resistor ER. The analog signal is converted into a digital signal through an analog/digital (A/D) converter (ADC) included in the MCU 62. The MCU 62 outputs, to the switch SW1, a pulse width modulation (PWM) signal in accordance with the temperature of the temperature detection resistor ER, which is indicated by the digital signal. The switch SW1 is a switching element provided on a direct-current path provided with the heating resistor 811. The switch SW1 opens or closes the direct-current path in accordance with the PWM signal. Accordingly, the degree of heat generation by the heating resistor 811 is controlled. The switch SW1 is, for example, a metal oxide semiconductor field effect transistor (MOSFET) but may be any other element that functions in the same manner.

FIG. 25 is a diagram illustrating an exemplary main circuit configuration for linking alternating current flowing through the heating resistor and temperature measurement. In the configuration illustrated in FIG. 25, the MCU 62 is coupled to the voltage divider circuit described above with reference to FIG. 12 and a switch SW2. The MCU 62 outputs, to the switch SW2, a PWM signal in accordance with the temperature of the temperature detection resistor ER, which is indicated by the digital signal. The switch SW2 is provided on an alternating-current path provided with the heating resistor 811. The switch SW2 opens or closes the alternating-current path in accordance with the PWM signal. Accordingly, the degree of heat generation by the heating resistor 811 is controlled. The switch SW2 is a bidirectional thyristor such as a triode AC switch (TRIAC) but may be any other element that functions in the same manner. The configuration described above with reference to FIG. 25 is the same as the configuration described above with reference to FIG. 24 except for matters otherwise stated.

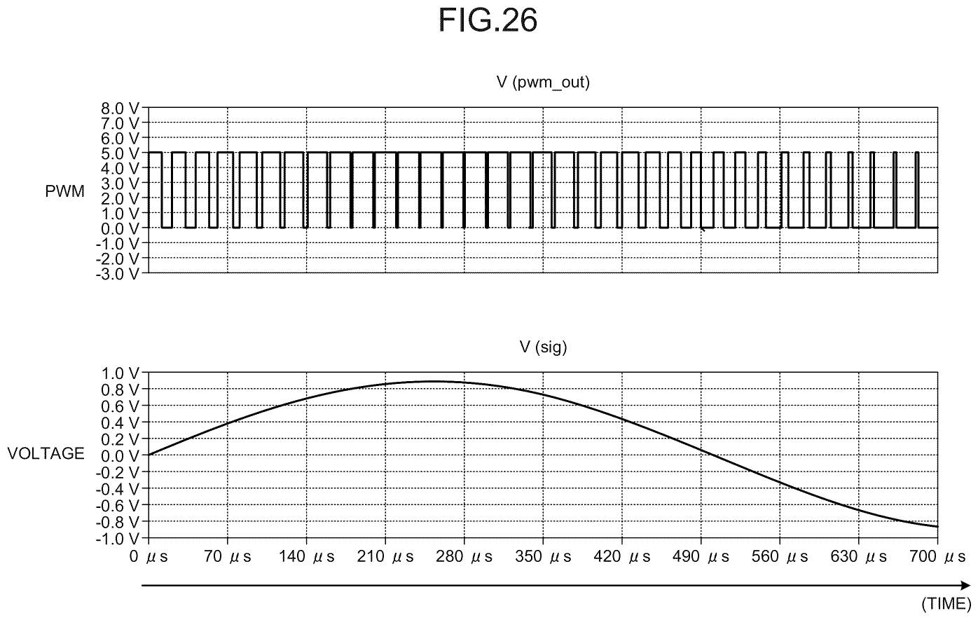

FIG. 26 is a graph illustrating an example of the relation between the pulse width of a PWM signal and voltage applied to the heating resistor 811. As illustrated in FIG. 26, voltage applied to the heating resistor 811 per unit time changes in accordance with the duty ratio of the PWM signal provided from the MCU 62 to the switch SW1 or the switch SW2. As the duration in which the output of the PWM signal in the unit time is non-zero is longer, voltage applied to the heating resistor 811 in the unit time is higher and the degree of heat generation by the heating resistor 811 is larger.

As the temperature of the temperature detection resistor ER, which is indicated by the output from the voltage divider circuit described above with reference to FIG. 12 is lower, the duration in which the output of the PWM signal in the unit time is non-zero is longer and the degree of heat generation by the heating resistor 811 is larger.

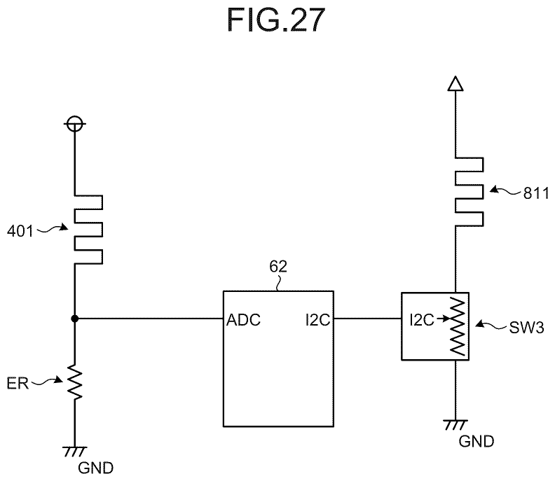

FIG. 27 is a diagram illustrating an exemplary circuit configuration in which a digital potentiometer is employed as a component related to heat generation amount control of the heating resistor 811. In a case where a switch SW3 as the digital potentiometer is employed in place of the switch SW1 in the configuration described above with reference to FIG. 24, the MCU 62 outputs, to the switch SW3, a signal (control signal) for controlling the electric resistance value of the switch SW3 to an electric resistance value in accordance with the output from the voltage divider circuit. The switch SW3 generates the electric resistance value in accordance with the control signal on the direct-current path where the heating resistor 811 is provided. Accordingly, the degree of heat generation by the heating resistor 811 is controlled. The configuration described above with reference to FIG. 27 is the same as the configuration described above with reference to FIG. 24 except for matters otherwise stated.

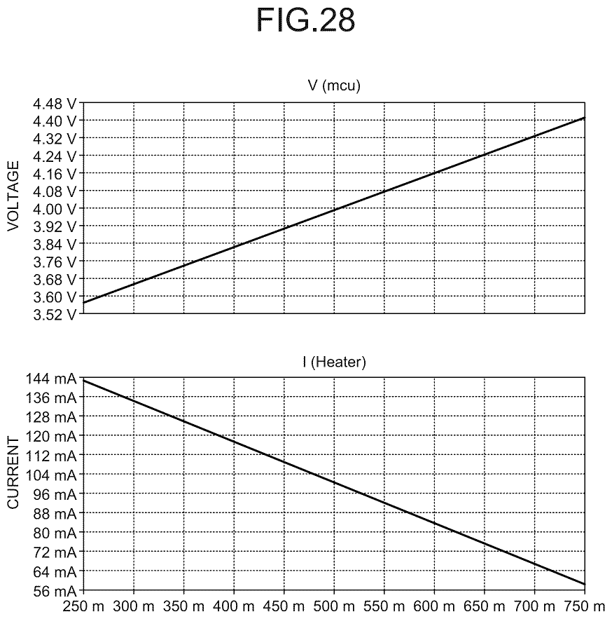

FIG. 28 is a graph illustrating a relation that current flowing to a heater device decreases as the potential of a part divided by the digital potentiometer and the heater device increases. Control is performed such that the electric resistance value of the switch SW3 is smaller as the temperature of the temperature detection resistor ER, which is indicated by the output from the voltage divider circuit described above with reference to FIG. 12, is lower. As the electric resistance value of the switch SW3 is smaller, voltage is lower and current is larger on the direct-current path where the heating resistor 811 is provided. As current on the direct-current path where the heating resistor 811 is provided is larger, the degree of heat generation by the heating resistor 811 is larger.

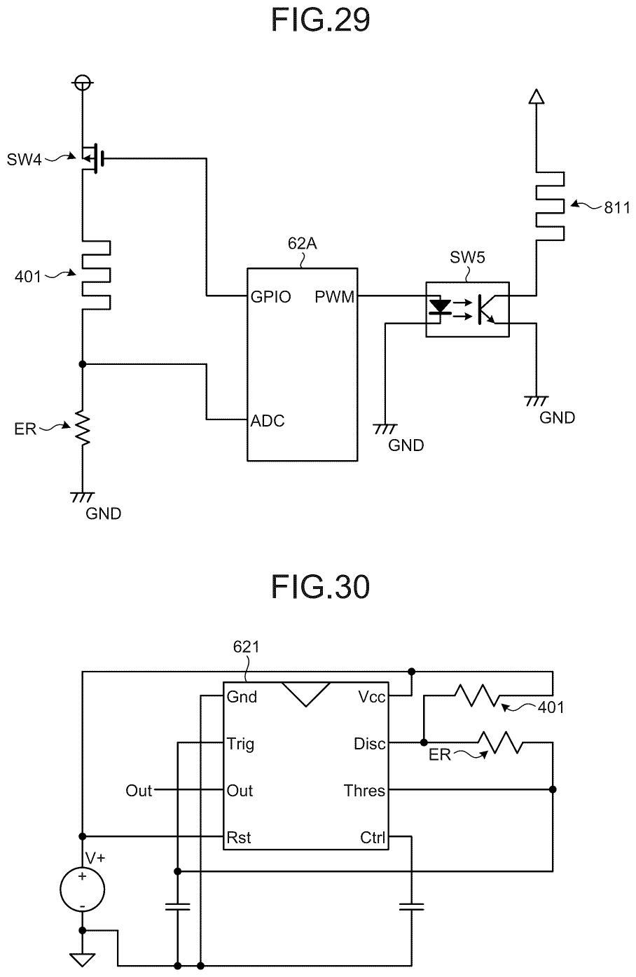

FIG. 29 is a diagram illustrating an exemplary circuit configuration in which ON/OFF circuits are added individually for a temperature sensor and a heater device and each is turned on and off to achieve low electric power consumption. An MCU 62A illustrated in FIG. 29 has a general purpose input/output (GPIO) function in addition to functions of the configuration of the MCU 62 described above with reference to FIG. 24. In the configuration illustrated in FIG. 29, the GPIO is used as a port for controlling operation of a switch SW4.

The switch SW4 is a load switch integrated circuit (IC) provided between the reference resistance element 401 in the voltage divider circuit described above with reference to FIG. 12 and a power source of the voltage divider circuit. The MCU 62A controls ON/OFF of the voltage divider circuit described above with reference to FIG. 12 by controlling ON/OFF of the switch SW4. For example, in a case where the above-described time division control is performed, operation control of turning on the voltage divider circuit in the detection duration and turning off the voltage divider circuit in the heating duration is employed.

In the configuration illustrated in FIG. 29, a switch SW5 is employed in place of the switch SW1. The switch SW5 is a photocoupler. Similarly to the switch SW1, the switch SW5 opens and closes the alternating-current path provided with the heating resistor 811 in accordance with the duty ratio of a PWM signal provided by the MCU 62. The configuration described above with reference to FIG. 29 is the same as the configuration described above with reference to FIG. 24 except for matters otherwise stated.

FIG. 30 is a diagram illustrating an exemplary circuit configuration in which the output from the voltage divider circuit is converted into a pulsed wave. A timer IC 621 illustrated in FIG. 30 converts the output from the voltage divider circuit described above with reference to FIG. 12, which is acquired from an input terminal Disc into a pulsed wave and outputs the pulsed wave from an output terminal Out. The frequency of the pulsed wave depends on the size of the output from the voltage divider circuit described above with reference to FIG. 12. Specifically, the electric resistance value of the temperature detection resistor ER is larger as the temperature of the temperature detection resistor ER is higher. The higher the electric resistance value of the temperature detection resistor ER, the lower the frequency of the pulse wave.

The ADC can be omitted from the MCU 62 by employing the timer IC 621. Specifically, the pulsed wave output from the timer IC 621 can be input as a digital signal to the MCU 62 when the timer IC 621 is provided between the voltage divider circuit described above with reference to FIG. 12 and the MCU 62. The pulsed wave output from the timer IC 621 is, for example, a square wave but may be any other pulsed wave that can be used as a digital signal.

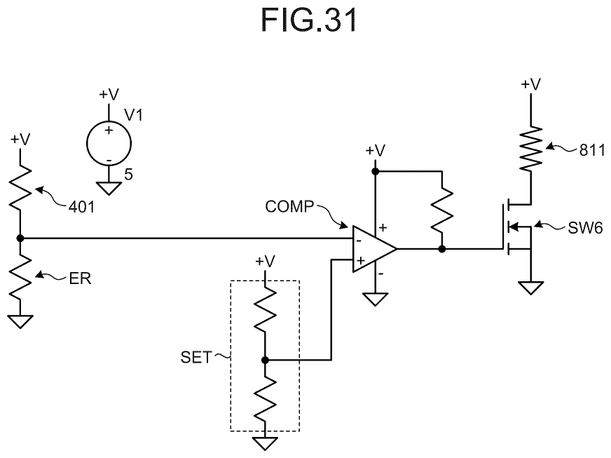

FIG. 31 is a diagram illustrating an exemplary circuit configuration for controlling the size of a current flowing to the heating resistor 811 in accordance with the output from the voltage divider circuit described above with reference to FIG. 12 without using an MCU such as the MCU 62. In the configuration illustrated in FIG. 31, a comparator COMP is provided as a component that receives the output from the voltage divider circuit described above with reference to FIG. 12. The comparator COMP provides, to a switch SW6, an output in accordance with a result of comparison between the output from the voltage divider circuit described above with reference to FIG. 12 and an output from a setting circuit SET having a predetermined electric resistance value. The switch SW6 opens or closes the alternating-current path provided with the heating resistor 811 in accordance with the output from the comparator COMP. The configuration described above with reference to FIG. 31 is the same as the configuration described above with reference to FIG. 24 except for matters otherwise stated.

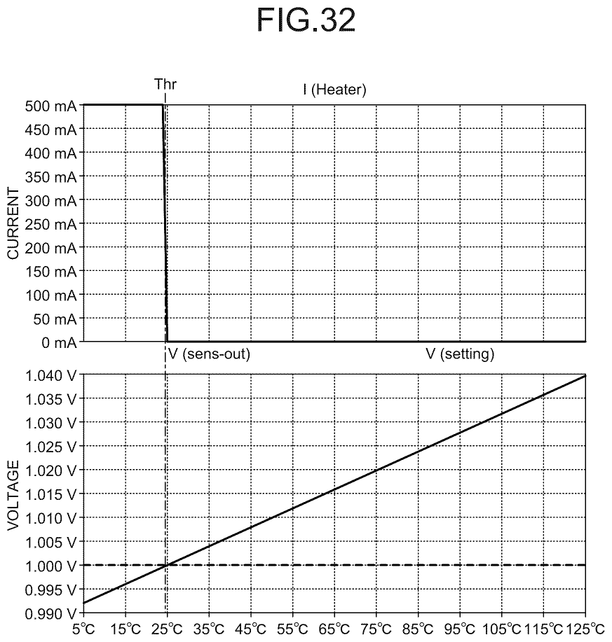

FIG. 32 is a graph illustrating turning-off of the heater device at a time point when the temperature sensor reaches 25° C. and illustrating a series of operations when the setting circuit SET in FIG. 31 is set to 1 V. As the temperature of the temperature detection resistor ER increases, the electric resistance value of the voltage divider circuit described above with reference to FIG. 12 on the ground (GND) side increases, and accordingly, the voltage of the output from the voltage divider circuit increases. The comparator COMP opens or closes the switch SW6 in accordance with a result of comparison between the voltage of the output and the voltage of the output from the setting circuit SET. FIG. 32 illustrates an example in which a current flowing to the heating resistor 811 becomes zero in effect when the voltage of the output is input to the comparator COMP in a case where the temperature of the temperature detection resistor ER is equal to or higher than 25° C. and the current flows so that the heating resistor 811 generates heat in a case where the temperature of the temperature detection resistor ER is lower than 25° C. In FIG. 32, a threshold Thr for switching ON/OFF of the current to the heating resistor 811 is 25° C., but the threshold Thr depends on the voltage of the output from the setting circuit SET and may be an optional temperature.

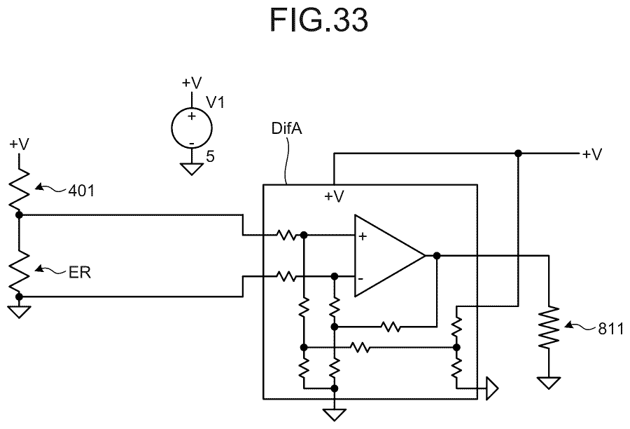

FIG. 33 is a diagram illustrating an example of achieving precise resistance value measurement by detecting potential difference between both ends of the temperature detection resistor ER in measurement using a differential amplification circuit. In the configuration illustrated in FIG. 33, a differential amplifier DifA is provided that generates an output in accordance with the difference between the voltage of the output from the voltage divider circuit described above with reference to FIG. 12 and the voltage of the voltage divider circuit on the ground (GND) side. When the output from the differential amplifier DifA is provided as power source input to the heating resistor 811, heat can be generated at the heating resistor 811 in accordance with the output from the voltage divider circuit described above with reference to FIG. 12.

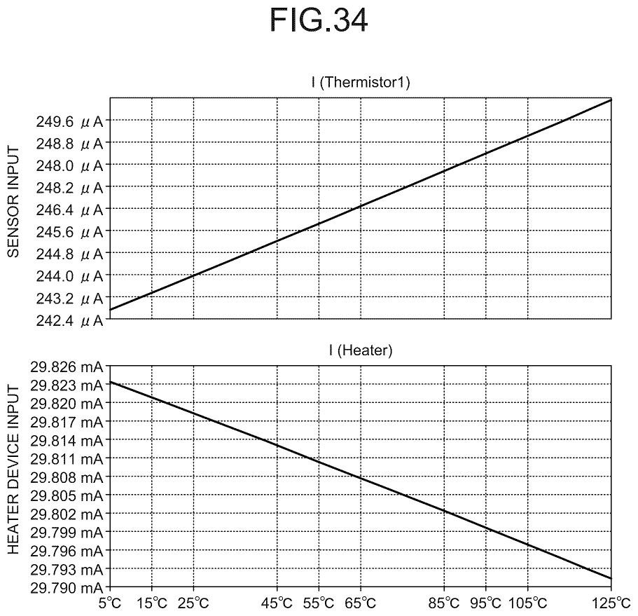

FIG. 34 is a graph illustrating an exemplary relation among the temperature of the temperature detection resistor ER, the voltage of the output from the voltage divider circuit described above with reference to FIG. 12, sensor output, and heater device input. The sensor output in FIG. 34 is a current generated in accordance with a difference from the voltage of the voltage divider circuit on the ground (GND) side. The heater device input is a current flowing to the heating resistor 811. As illustrated in FIG. 34, the sensor output increases and the heater device input decreases as the temperature increases.

Even when the MCU 62 is unnecessary for operation control of the heating resistor 811 in accordance with the temperature of the temperature detection resistor ER, a component for performing processing corresponding to an output from the information processing device 300 is provided. The component may be the FPGA 63, the MCU 62, or a non-illustrated dedicated component.

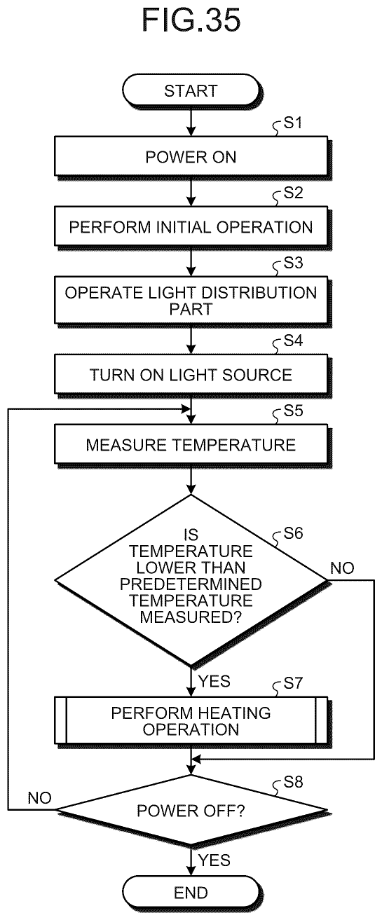

FIG. 35 is a flowchart illustrating the process of operation processing of the illumination device 50. When the illumination device 50 is powered on (step S1), each component provided on the system substrate 60 performs initial operation (step S2). As a specific example, the MCU 62 performs processing corresponding to an operation mode (light emission intensity, light distribution range, and the like) designated by a signal transmitted from the information processing device 300 so that the illumination device 50 operates in the operation mode. The FPGA 63, the light source driver 65, and the like start operation under operation control by the MCU 62.

After the processing at step S2, the light adjustment device 700 operates (step S3) and the transmittance of light through the light adjustment device 700 is controlled so that light is incident in a light distribution range designated in the above-described operation mode. After the processing at step S3, the light source 52 is turned on (step S4).

Subsequently, temperature measurement is performed (step S5). Specifically, the MCU 62 operates the temperature sensor 400 and acquires information related to the temperature of the liquid crystal panel 1 by acquiring an output from each signal output line Vout(k). Data indicating the correspondence relation between the magnitude of an output from each signal output line Vout(k) and the temperature of the liquid crystal panel 1 provided with the temperature sensor 400 is obtained by experiment or the like in advance and reflected on operation of the MCU 62 or 62A, the setting circuit SET, or the differential amplifier DifA.

The MCU 62 determines whether temperature lower than a predetermined temperature is measured in the processing at step S5 (step S6). In a case where temperature lower than the predetermined temperature is measured (Yes at step S6), the MCU 62 performs heating processing (step S7).

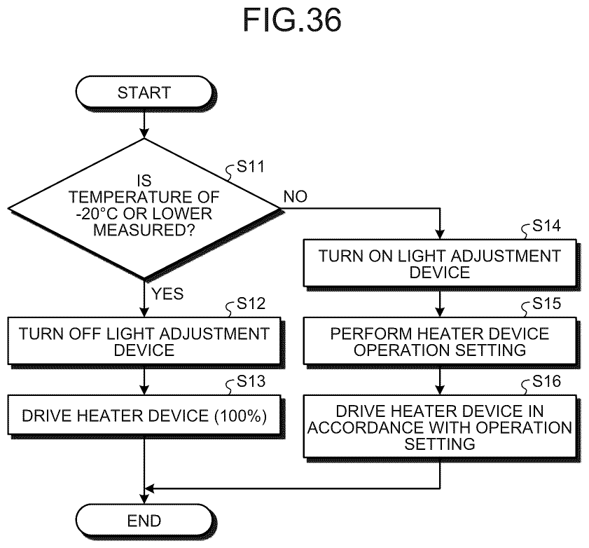

FIG. 36 is a flowchart illustrating the process of the heating processing (step S7) in FIG. 35. In a case where the temperature of −20° C. or lower is measured in the above-described processing at step S5 (Yes at step S11), the MCU 62 turns off operation of the light adjustment device 700 (step S12). The heating resistor 811 is driven at predetermined maximum heat generation capacity (100%) (step S13). The state in which the heating resistor 811 is driven at the predetermined maximum heat generation capacity (100%) refers to a state in which maximum current in the range of current allowed by the heating resistor 811 is provided to the heating resistor 811.

In a case where the temperature of −20° C. or lower is not measured in the above-described processing at step S5 (No at step S11), the MCU 62 turns on operation of the light adjustment device 700 (step S14). In accordance with predetermined heater device operation setting (step S15), heater device drive is performed (step S16).

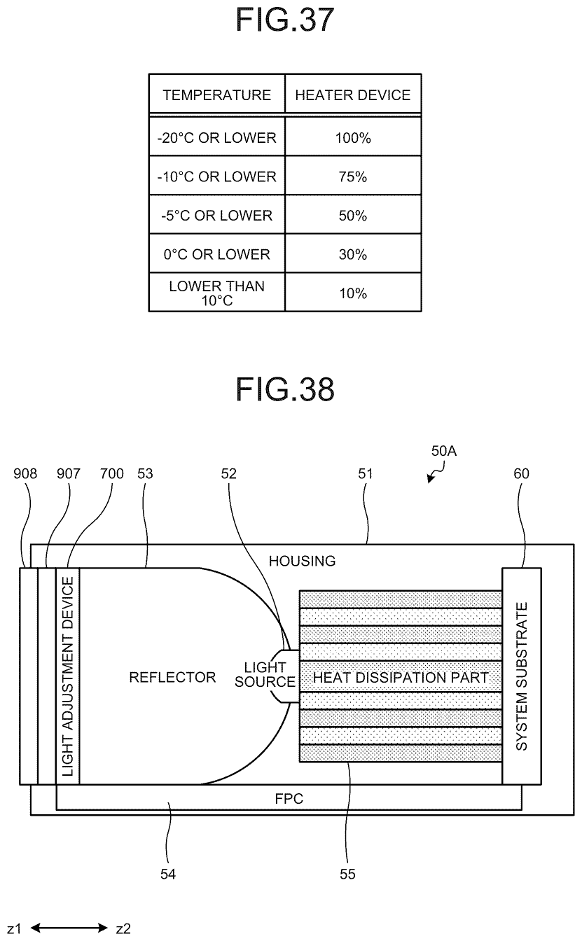

FIG. 37 is a diagram illustrating an example of the predetermined heater device operation setting described as operation at step S15. With the setting illustrated FIG. 37, the heater device is driven at the predetermined maximum heat generation capacity (100%) when −20° C. or lower is measured as the temperature of the temperature detection resistor ER, the heater device is driven at 75% of the predetermined maximum heat generation capacity when temperature higher than −20° C. and equal to or lower than −10° C. is measured, the heater device is driven at 50% of the predetermined maximum heat generation capacity when temperature higher than −10° C. and equal to or lower than −5° C. is measured, the heater device is driven at 30% of the predetermined maximum heat generation capacity when temperature higher than −5° C. and equal to or lower than 0° C. is measured, and the heater device is driven at 10% of the predetermined maximum heat generation capacity when temperature higher than 0° C. and lower than 10° C. is measured. The heater device operation setting described above with reference to FIG. 37 is merely exemplary and not a limiting example but may be changed as appropriate.

After the heating processing (step S7) illustrated in FIG. 35, the process proceeds to the processing at step S5 again unless the illumination device 50 is powered off (No at step S8). In a case where the illumination device 50 is powered off (Yes at step S8), operation of the illumination device 50 ends. In a case where temperature lower than the predetermined temperature is not measured in the processing at step S5 (No at step S6), the processing at step S7 is not performed and the process proceeds to the bifurcation at step S8.

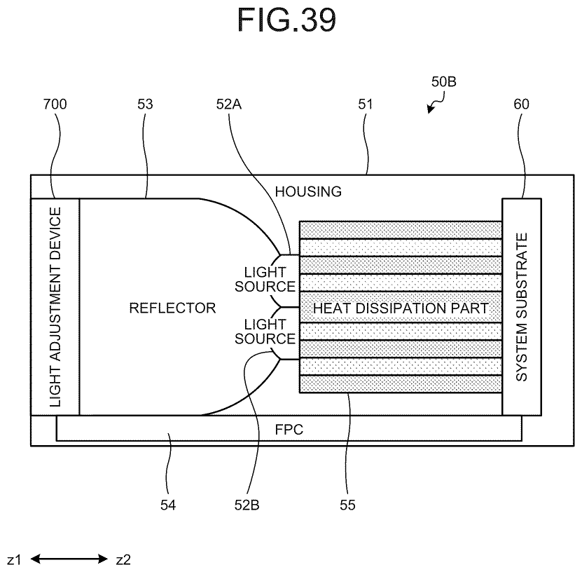

Despite the above description related to the illumination device 50 explained with reference to FIG. 1, the specific form of the illumination device is not limited to that illustrated in FIG. 1. For example, an illumination device 50A illustrated in FIG. 38 or an illumination device 50B illustrated in FIG. 39 may be employed.

FIG. 38 is a schematic diagram illustrating a main configuration of the illumination device 50A. The illumination device 50A includes a third component 907 and a fourth component 908 in place of the first component 905 and the second component 906 included in the illumination device 50 described above with reference to FIG. 1. The third component 907 is provided on a side (z1 direction side) opposite the reflector 53 with respect to the light adjustment device 700. The fourth component 908 is provided on the z1 direction side relative to the third component 907. One of the third component 907 and the fourth component 908 may be the temperature sensor 400 and the other may be the heater 800, but at least one of the third component 907 and the fourth component 908 may be any other component. The other configuration is, for example, a polarization plate or a light adjustment mirror.

The polarization plate transmits light polarized in a particular direction and blocks light polarized in the other direction. The polarization direction of light that can transmit through the polarization plate can be optionally determined at timing of designing. The polarization plate blocks part of light, and thus heating due to infrared included in the light can be expected.

The light adjustment mirror has a stacked configuration of liquid crystal display panels in which the liquid crystal layer is an electrochromic layer and of a semi-reflective mirror. The electrochromic layer includes a thin film of an electrochromic material such as WO3, NbO5, or TiO2 and an electrolyte solution. The light adjustment mirror has an effect of reducing yellowing of light and obtaining blueish visibility. The semi-reflective mirror of the light adjustment mirror is provided to reflect, to the z2 direction side, part of light traveling the z2 direction side toward the z1 direction side. With the light adjustment mirror, heating of the liquid crystal panels 1 due to infrared included in reflected light can be expected.

One of the third component 907 and the fourth component 908 may be one of the polarization plate and the light adjustment mirror and the other of the third component 907 and the fourth component 908 may be the other of the polarization plate and the light adjustment mirror, or the third component 907 may be a component (for example, the temperature sensor and heater 900, the heater 800, or the heater 800A) having a heater device function and the fourth component 908 may be the polarization plate or the light adjustment mirror. Although not illustrated, the second component 906 illustrated in FIG. 1 may be additionally provided as the temperature sensor 400 in a case where the third component 907 is the heater 800 and the fourth component 908 is the polarization plate or the light adjustment mirror.

FIG. 39 is a schematic diagram illustrating a main configuration of the illumination device 50B. The illumination device 50B includes a plurality of light sources. In FIG. 39, the illumination device 50B includes, for example, two light sources 52A and 52B, and may include three or more light sources.

Although not illustrated for the illumination device 50B, a temperature sensor (for example, the temperature sensor 400) is provided in an illumination device including a plurality of light sources as in the illumination device 50 described above with reference to FIG. 1. In the illumination device including a plurality of light sources, the light sources are turned on in a case where temperature lower than a predetermined temperature (for example, lower than 10° C.) is detected by the temperature sensor. Accordingly, heating of the illumination device (liquid crystal panels 1, in particular) due to heat generation at the light sources can be expected. In a case where temperature equal to or higher than the predetermined temperature (for example, equal to or higher than 10° C.) is detected by the temperature sensor, one of the light sources is turned on. The operation of the light adjustment device 700 is desirably controlled so that light externally emitted from the illumination device is constant irrespective of the number of light sources turned on.

As described above, according to the embodiment, an illumination device (for example, the illumination device 50, 50A, or 50B) includes a light source (light source 52) configured to emit light, a light adjustment device (light adjustment device 700) including at least one liquid crystal panel (liquid crystal panel 1) on a light outputting side of the light source and configured to adjust the light distribution range of light externally emitted from the liquid crystal panel by controlling each of the transmittance of light transmitting through the liquid crystal panel and the transmission range of light transmitting through the liquid crystal panel, a temperature sensor (temperature sensor 400, partial temperature detection region PA, or temperature sensor and heater 900 or 900A) configured to acquire information indicating the temperature of the liquid crystal panel, a heater (heater 800, 801, or 800A, temperature sensor and heater 900 or 900A, partial heating region HPA, or a plurality of light sources) configured to heat the liquid crystal panel, and a controller (MCU 62 or 62A, timer IC 621, comparator COMP, or differential amplifier DifA) configured to operate the heater in a case where information indicating a temperature equal to or lower than a predetermined temperature is obtained by the temperature sensor. Thus, with the heater, it is possible to reduce decrease of the temperature of the liquid crystal panel included in the light adjustment device and provided on the emission path of light from the light source. Moreover, since the heater is operated when information indicating a temperature equal to or lower than the predetermined temperature is acquired by the temperature sensor, the heater can be appropriately operated when heating of the liquid crystal panel is necessary.

The heater (temperature sensor and heater 900 or 900A or partial heating region HPA) is a heater device including a first conductive wire part (heating resistor 811) that generates heat in accordance with electric power supply, and accordingly, it is extremely easy to dispose the heater in contact with the liquid crystal panel (liquid crystal panel 1) and it is possible to excellently heat the liquid crystal panel.

The temperature sensor (temperature sensor 400) includes a second conductive wire part (temperature detection resistor ER) having an electric resistance value that changes with temperature, and the first conductive wire part (heating resistor 811) and the second conductive wire part are provided on the same surface of the liquid crystal panel (liquid crystal panel 1) (refer to FIGS. 20 to 22, for example). Accordingly, it is possible to reduce thickness increase of components on the emission path of light due to the first conductive wire part and the second conductive wire part.

The heater (heater 800 or 801) supplies electric power to the second conductive wire part (temperature detection resistor ER) to cause the second conductive wire part to generate heat. Accordingly, it is possible to further reduce attenuation of light from the light source (light source 52) due to the conductive wire.

The illumination device (for example, illumination device 50B) further includes a reflection part (light adjustment mirror) configured to reflect part of light passing through the light adjustment device (light adjustment device 700) from the light source (light source 52 or one of the light sources 52A and 52B) to the light source side. Accordingly, it is possible to heat the light adjustment device with an increased number of heat sources.

The illumination device (for example, illumination device 50B) further includes a polarization plate provided in the light adjustment device (light adjustment device 700) and configured to transmit light in a specific polarization direction and block light in the other polarization direction. Accordingly, it is possible to heat the light adjustment device with an increased number of heat sources.

A plurality of light sources (for example, light sources 52A and 52B) are provided and one or more of the light sources operate as a heater, and accordingly, operation for external illumination and operation for heating of the illumination device can be both achieved by operation control of the light sources without redundantly providing a heater device.

The specific structure of the light adjustment device 700 is not limited to the example described above with reference to FIG. 2. For example, the light adjustment device 700 may include a liquid crystal panel that functions as what is called a liquid crystal lens provided to allow change of the refraction degree of light traveling from one surface side toward the other surface side by light distribution control of liquid crystals.

Other effects that are achieved by aspects described above in the present embodiment and obvious from description of the present specification or can be thought of by the skilled person in the art as appropriate should be considered as effects achieved by the present disclosure.

What is claimed is:

1. An illumination device comprising:
a light source configured to emit light;
a light adjustment device including at least one liquid crystal panel on a light outputting side of the light source and configured to adjust a light distribution range of light externally emitted from the liquid crystal panel by controlling each of transmittance of light transmitting through the liquid crystal panel and a transmission range of light transmitting through the liquid crystal panel;
a temperature sensor configured to acquire information indicating a temperature of the liquid crystal panel;
a heater configured to heat the liquid crystal panel; and
a controller configured to operate the heater in a case where information indicating a temperature equal to or lower than a predetermined temperature is obtained by the temperature sensor.

2. The illumination device according to claim 1, wherein the heater is a heater device including a first conductive wire part that generates heat in accordance with electric power supply.

3. The illumination device according to claim 2, wherein
the temperature sensor includes a second conductive wire part having an electric resistance value that changes with temperature, and
the first conductive wire part and the second conductive wire part are provided on the same surface of the liquid crystal panel.

4. The illumination device according to claim 3, wherein the heater supplies electric power to the second conductive wire part to cause the second conductive wire part to generate heat.

5. The illumination device according to claim 1, further comprising a reflection part configured to reflect part of light passing through the light adjustment device from the light source to the light source side.

6. The illumination device according to claim 1, further comprising a polarization plate provided in the light adjustment device and configured to transmit light in a specific polarization direction and block light in the other polarization direction.

7. The illumination device according to claim 1, wherein
a plurality of the light sources are provided, and
one or more of the light sources operate as the heater.
